(19) United States
(12) Patent Application Publication
(10) Pub. No.: US 2023/0030066 A1
(43) Pub. Date: Feb. 2, 2023

(54) INTRA-BAND CARRIER AGGREGATION/DUAL CONNECTIVITY

(71) Applicant: QUALCOMM Incorporated, San Diego, CA (US)

(72) Inventors: Kazuki Takeda, Tokyo (JP); Valentin Alexandru Gheorghiu, Tokyo (JP)

(21) Appl. No.: 17/388,910

(22) Filed: Jul. 29, 2021

(51) Int. Cl. H04W 72/12; H04W 76/15

(52) U.S. Cl. CPC H04W 72/1278; H04W 76/15

(57) ABSTRACT

Methods, systems, and devices for wireless communications are described. A user equipment (UE) may identify a set of carriers within a frequency band for communicating with a base station via either carrier aggregation or dual connectivity. The UE may determine that a first parameter for communications over a first carrier exceeds a threshold with respect to corresponding parameters of other carriers, the first parameter being either a downlink reception parameter or an uplink transmission parameter. The UE may refrain from communicating over the first carrier based at least in part on the first parameter exceeding the threshold.

### FIELD OF TECHNOLOGY

The following relates to wireless communications, including intra-band carrier aggregation/dual connectivity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support intra-band carrier aggregation (CA)/dual connectivity (DC). Generally, the described techniques provide for a user equipment (UE) and/or base station to adapt to base stations in an intra-band CA/DC communication scenario. For example, the UE may identify a timing/power differential on respective carriers between the intra-band CA/DC base stations with respect to a threshold. Based on the timing/power differential for the different carriers, the UE may refrain from communicating with the base station whose carrier timing or reception/transmission power differs by more than a threshold with that of the carriers of other base stations participating in the CA/DC communications. For example, the UE may refrain from monitoring for downlink receptions on carriers from the different base station (the base station whose timing or power levels differ from that of other base stations) or refrain from performing uplink transmissions to the different base station on its carrier. Where one or more of the base stations has timing or power that differs from that of other base stations (as observed through signals received or transmitted on base station-specific component carriers), the UE may restrict the base stations with which the UE may communicate to only base stations whose timing/power is within the thresholds with respect to each other. For example, if the carriers of two base stations are within the differential thresholds and one is not, the UE may communicate with the two base stations or with the one that is not using their/the respective carrier, but the UE would not communicate with a combination of the base stations. On the base station side, one or more of the base stations may identify the differences (e.g., timing and/or power) between the base stations and avoid scheduling communications with the UE using the respective carriers based on the differences. References to the base stations described herein may be the same type of base station or may be different types of base stations (e.g., may be conventional base stations, TRPs, cells, and the like). In some aspects, references to base stations participating in the intra-band CA/DC communications may, in some example, refer to different antennas of the same base station (e.g., non-co-located antennas operating using different intra-band carrier).

A method for wireless communications at a UE is described. The method may include identifying a set of carriers within a frequency band for communicating with a base station via either CA or DC, determining that a first parameter for communications over a first carrier exceeds a threshold with respect to corresponding parameters of other carriers, the first parameter being either a downlink reception parameter or an uplink transmission parameter, and refraining from communicating over the first carrier based on the first parameter exceeding the threshold.

An apparatus for wireless communications at a UE is described. The apparatus may include a processor, memory coupled with the processor, and instructions stored in the memory. The instructions may be executable by the processor to cause the apparatus to identify a set of carriers within a frequency band for communicating with a base station via either CA or DC, determine that a first parameter for communications over a first carrier exceeds a threshold with respect to corresponding parameters of other carriers, the first parameter being either a downlink reception parameter or an uplink transmission parameter, and refrain from communicating over the first carrier based on the first parameter exceeding the threshold.

Another apparatus for wireless communications at a UE is described. The apparatus may include means for identifying a set of carriers within a frequency band for communicating with a base station via either CA or DC, means for determining that a first parameter for communications over a first carrier exceeds a threshold with respect to corresponding parameters of other carriers, the first parameter being either a downlink reception parameter or an uplink transmission parameter, and means for refraining from communicating over the first carrier based on the first parameter exceeding the threshold.

A non-transitory computer-readable medium storing code for wireless communications at a UE is described. The code may include instructions executable by a processor to identify a set of carriers within a frequency band for communicating with a base station via either CA or DC, determine that a first parameter for communications over a first carrier exceeds a threshold with respect to corresponding parameters of other carriers, the first parameter being either a downlink reception parameter or an uplink transmission parameter, and refrain from communicating over the first carrier based on the first parameter exceeding the threshold.

In some examples of the method, apparatuses, and non-transitory computer-readable medium described herein, refraining from communicating over the first carrier may include operations, features, means, or instructions for refraining from monitoring for the downlink reception on the first carrier.

Some examples of the method, apparatuses, and non-transitory computer-readable medium described herein may further include operations, features, means, or instructions for determining a downlink receive timing for each carrier in the set of carriers and determining, based on the downlink receive timing for each carrier, that a downlink receive timing difference associated with the first carrier with respect to other carriers exceeds the threshold, where the first parameter includes the downlink receive timing difference.

Some examples of the method, apparatuses, and non-transitory computer-readable medium described herein may further include operations, features, means, or instructions for determining a receive power for each carrier in the set of carriers and determining, based on the receive power for each carrier, that a downlink receive power difference associated with the first carrier with respect to other carriers exceeds the threshold, where the first parameter includes the downlink receive power difference.

Some examples of the method, apparatuses, and non-transitory computer-readable medium described herein may further include operations, features, means, or instructions for determining a time period for refraining from communicating over the first carrier based on a downlink reception over a second carrier of the set of carriers and the first parameter exceeding the threshold, where the UE refrains from communicating over the first carrier during the time period.

Some examples of the method, apparatuses, and non-transitory computer-readable medium described herein may further include operations, features, means, or instructions for transmitting a message indicating UE capability information for a support for communicating using the set of carriers with either the CA or the DC, where the time period may be based on the UE capability information.

In some examples of the method, apparatuses, and non-transitory computer-readable medium described herein, the time period includes one or more symbols or one or more slots.

Some examples of the method, apparatuses, and non-transitory computer-readable medium described herein may further include operations, features, means, or instructions for determining, subsequent to the refraining, that a second parameter for communicating over a second carrier of the set of carriers exceeds the threshold and communicating over the first carrier and the second carrier based on the first parameter and the second parameter exceeding the threshold.

Some examples of the method, apparatuses, and non-transitory computer-readable medium described herein may further include operations, features, means, or instructions for determining that the first carrier may be associated with a non-primary cell associated with the UE, where the refraining may be based on the first carrier being associated with the non-primary cell and the first parameter exceeding the threshold.

Some examples of the method, apparatuses, and non-transitory computer-readable medium described herein may further include operations, features, means, or instructions for determining that a first downlink reception over the first carrier begins after a second downlink reception over a second carrier of the set of carriers, where the refraining may be based on the first downlink reception beginning after the second downlink reception, the first parameter based on a timing difference between the first downlink reception and the second downlink reception.

Some examples of the method, apparatuses, and non-transitory computer-readable medium described herein may further include operations, features, means, or instructions for determining that a first downlink reception over the first carrier begins before a second downlink reception over a second carrier of the set of carriers, where the refraining may be based on the first downlink reception beginning before the second downlink reception, the first parameter based on a timing difference between the first downlink reception and the second downlink reception.

Some examples of the method, apparatuses, and non-transitory computer-readable medium described herein may further include operations, features, means, or instructions for determining that a first receive power associated with the first carrier may be lower than a second receive power level associated with a second carrier of the set of carriers, where the refraining may be based on the first receive power being lower than the second receive power, the first parameter based on a receive power difference between the first receive power and the second receive power.

Some examples of the method, apparatuses, and non-transitory computer-readable medium described herein may further include operations, features, means, or instructions for transmitting a message indicating the first parameter for communications over the first carrier.

In some examples of the method, apparatuses, and non-transitory computer-readable medium described herein, the message may be transmitted using a physical uplink control channel (PUCCH) message, a physical uplink shared channel (PUSCH) message, a medium access control (MAC) control element (CE), or a combination thereof, and may be transmitted periodically or aperiodically.

In some examples of the method, apparatuses, and non-transitory computer-readable medium described herein, refraining from communicating over the first carrier may include operations, features, means, or instructions for refraining from transmitting an uplink transmission on the first carrier.

Some examples of the method, apparatuses, and non-transitory computer-readable medium described herein may further include operations, features, means, or instructions for determining an uplink transmission timing for each carrier in the set of carriers and determining, based on the uplink transmission timing for each carrier, that an uplink transmit timing difference associated with the first carrier with respect to other carriers exceeds the threshold, where the first parameter includes the uplink transmit timing difference.

Some examples of the method, apparatuses, and non-transitory computer-readable medium described herein may further include operations, features, means, or instructions for determining an uplink transmit power for each carrier in the set of carriers and determining, based on the uplink transmit power for each carrier, that an uplink transmit power difference associated with the first carrier with respect to other carriers exceeds the threshold, where the first parameter includes the uplink transmit power difference.

Some examples of the method, apparatuses, and non-transitory computer-readable medium described herein may further include operations, features, means, or instructions for determining a time period for refraining from communicating over the first carrier based on an uplink transmission over a second carrier of the set of carriers and the first parameter exceeding the threshold, where the UE refrains from communicating over the first carrier during the time period.

Some examples of the method, apparatuses, and non-transitory computer-readable medium described herein may further include operations, features, means, or instructions for transmitting, prior to determining that the first parameter exceeds the threshold, a UE capability message indicating a support for communicating over the set of carriers using either the CA or the DC, where the time period may be based on the UE capability message.

In some examples of the method, apparatuses, and non-transitory computer-readable medium described herein, the time period includes one or more symbols or one or more slots.

Some examples of the method, apparatuses, and non-transitory computer-readable medium described herein may further include operations, features, means, or instructions for determining that a first uplink transmission over the first carrier begins after a second uplink transmission over a second carrier of the set of carriers, where the refraining may be based on the first uplink transmission beginning after the second uplink transmission, the first parameter based on a timing difference between the first uplink transmission and the second uplink transmission.

Some examples of the method, apparatuses, and non-transitory computer-readable medium described herein may further include operations, features, means, or instructions for determining that a first uplink transmission over the first carrier begins before a second uplink transmission over a second carrier of the set of carriers, where the refraining may be based on the first uplink transmission beginning before the second uplink transmission, the first parameter based on a timing difference between the first uplink transmission and the second uplink transmission.

A method for wireless communications at a base station is described. The method may include identifying, for a UE, a set of carriers within a frequency band for communicating with the UE via either CA or DC, determining, for each carrier in the set of carriers, a parameter for communications over the carrier within the frequency band, the parameter being either a downlink reception parameter or an uplink transmission parameter, determining a threshold with respect to the parameter associated with each carrier of the set of carriers, and scheduling communications with the UE based on the parameter with respect to the carriers in the set of carriers satisfying the threshold.

An apparatus for wireless communications at a base station is described. The apparatus may include a processor, memory coupled with the processor, and instructions stored in the memory. The instructions may be executable by the processor to cause the apparatus to identify, for a UE, a set of carriers within a frequency band for communicating with the UE via either CA or DC, determine, for each carrier in the set of carriers, a parameter for communications over the carrier within the frequency band, the parameter being either a downlink reception parameter or an uplink transmission parameter, determine a threshold with respect to the parameter associated with each carrier of the set of carriers, and schedule communications with the UE based on the parameter with respect to the carriers in the set of carriers satisfying the threshold.

Another apparatus for wireless communications at a base station is described. The apparatus may include means for identifying, for a UE, a set of carriers within a frequency band for communicating with the UE via either CA or DC, means for determining, for each carrier in the set of carriers, a parameter for communications over the carrier within the frequency band, the parameter being either a downlink reception parameter or an uplink transmission parameter, means for determining a threshold with respect to the parameter associated with each carrier of the set of carriers, and means for scheduling communications with the UE based on the parameter with respect to the carriers in the set of carriers satisfying the threshold.

A non-transitory computer-readable medium storing code for wireless communications at a base station is described. The code may include instructions executable by a processor to identify, for a UE, a set of carriers within a frequency band for communicating with the UE via either CA or DC, determine, for each carrier in the set of carriers, a parameter for communications over the carrier within the frequency band, the parameter being either a downlink reception parameter or an uplink transmission parameter, determine a threshold with respect to the parameter associated with each carrier of the set of carriers, and schedule communications with the UE based on the parameter with respect to the carriers in the set of carriers satisfying the threshold.

In some examples of the method, apparatuses, and non-transitory computer-readable medium described herein, the scheduling may include operations, features, means, or instructions for refraining from scheduling a downlink transmission to the UE on a carrier based on a maximum receive timing difference of the downlink transmission exceeding the threshold with respect to downlink transmissions to the UE over other carriers in the set of carriers.

In some examples of the method, apparatuses, and non-transitory computer-readable medium described herein, the scheduling may include operations, features, means, or instructions for refraining from scheduling a downlink transmission to the UE on a carrier based on a maximum receive power difference of the downlink transmission exceeding the threshold with respect to downlink transmissions to the UE over other carriers in the set of carriers.

In some examples of the method, apparatuses, and non-transitory computer-readable medium described herein, the scheduling may include operations, features, means, or instructions for refraining from scheduling an uplink transmission from the UE on a carrier based on a maximum transmit timing difference of the uplink transmission exceeding the threshold with respect to uplink transmissions from the UE over other carriers in the set of carriers.

In some examples of the method, apparatuses, and non-transitory computer-readable medium described herein, the scheduling may include operations, features, means, or instructions for refraining from scheduling an uplink transmission from the UE on a carrier based on a maximum receive power difference of the uplink transmission exceeding the threshold with respect to a receive power of uplink transmissions from the UE over other carriers in the set of carriers.

Some examples of the method, apparatuses, and non-transitory computer-readable medium described herein may further include operations, features, means, or instructions for receiving a UE capability message indicating the threshold supported by the UE for either CA or DC over the set of carriers within the frequency band, where the threshold includes a maximum receive timing difference, a maximum transmit timing difference, a maximum receive power difference, or a combination thereof.

### BRIEF DESCRIPTION OF THE DRAWINGS

FIG. 1 illustrates an example of a wireless communications system that supports intra-band carrier aggregation (CA)/dual connectivity (DC) in accordance with aspects of the present disclosure.

FIG. 2 illustrates an example of a wireless communication system that supports intra-band CA/DC in accordance with aspects of the present disclosure.

FIGS. 3A and 3B illustrate examples of a carrier configuration that supports intra-band CA/DC in accordance with aspects of the present disclosure.

FIGS. 4A and 4B illustrate examples of a carrier configuration that supports intra-band CA/DC in accordance with aspects of the present disclosure.

FIGS. 5A and 5B illustrate examples of a carrier configuration that supports intra-band CA/DC in accordance with aspects of the present disclosure.

FIGS. 6A and 6B illustrate examples of a carrier configuration that supports intra-band CA/DC in accordance with aspects of the present disclosure.

FIGS. 7A and 7B illustrate examples of a carrier configuration that supports intra-band CA/DC in accordance with aspects of the present disclosure.

FIG. 8 illustrates an example of a carrier configuration that supports intra-band CA/DC in accordance with aspects of the present disclosure.

FIGS. 9 and 10 show block diagrams of devices that support intra-band CA/DC in accordance with aspects of the present disclosure.

FIG. 11 shows a block diagram of a communications manager that supports intra-band CA/DC in accordance with aspects of the present disclosure.

FIG. 12 shows a diagram of a system including a device that supports intra-band CA/DC in accordance with aspects of the present disclosure.

FIGS. 13 and 14 show block diagrams of devices that support intra-band CA/DC in accordance with aspects of the present disclosure.

FIG. 15 shows a block diagram of a communications manager that supports intra-band CA/DC in accordance with aspects of the present disclosure.

FIG. 16 shows a diagram of a system including a device that supports intra-band CA/DC in accordance with aspects of the present disclosure.

FIGS. 17 through 21 show flowcharts illustrating methods that support intra-band CA/DC in accordance with aspects of the present disclosure.

### DETAILED DESCRIPTION

Wireless communication systems may support carrier aggregation (CA) and/or dual-connectivity (DC) techniques where a UE performs intra-band communications with multiple base stations on respective carriers within the frequency band. These techniques are generally configured within frequency range 1 (FR1) and the techniques assume colocation between the base stations. Based on the colocation of the base stations, propagation delay differences associated with uplink and/or downlink communications were minimal (e.g., 3 us), which is within the cyclic prefix (CP) length. Accordingly, the maximum receive timing difference (MRTD) and/or power levels for the base stations has been within the CP length and the CA/DC communications are not impacted. However, advanced techniques for intra-band CA/DC communications may result in additional FRs being used as well as the base stations being non-co-located. This may result in the timing differential between the CA/DC base station carrier's being outside of the CP length. Absent the techniques described herein, this may result in the CA/DC communications being disrupted based on the differential base stations.

The described techniques relate to improved methods, systems, devices, and apparatuses that support intra-band CA/DC. Generally, the described techniques provide for a user equipment (UE) and/or base station to adapt to non-co-located base stations in an intra-band CA/DC communication scenario. For example, the UE may identify a timing/power differential on respective carriers in the intra-band CA/DC with respect to a threshold. Based on the timing/power differential for the different carriers, the UE may refrain from communicating with the carrier(s) whose carrier timing or reception/transmission power differs by more than a threshold with that of other carrier(s) in the CA/DC communications. For example, the UE may refrain from monitoring for downlink receptions on carriers or refrain from performing uplink transmissions on carrier(s). Where one or more of the base stations has timing or power that differs from that of other base stations (as observed through signals received or transmitted on base station-specific component carriers), the UE may restrict the base stations with which the UE may communicate to only base stations whose timing/power is within the thresholds with respect to each other. For example, if the carriers of two base stations are within the differential thresholds and one is not, the UE may communicate with the two base stations or with the one that is not using their/the respective carrier, but the UE would not communicate with a combination of the base stations. On the base station side, one or more of the base stations may identify the differences (e.g., timing and/or power) between the base stations and avoid scheduling communications with the UE using the respective carriers based on the differences.

Aspects of the disclosure are initially described in the context of wireless communications systems. Aspects of the disclosure are further illustrated by and described with reference to apparatus diagrams, system diagrams, and flowcharts that relate to intra-band CA/DC.

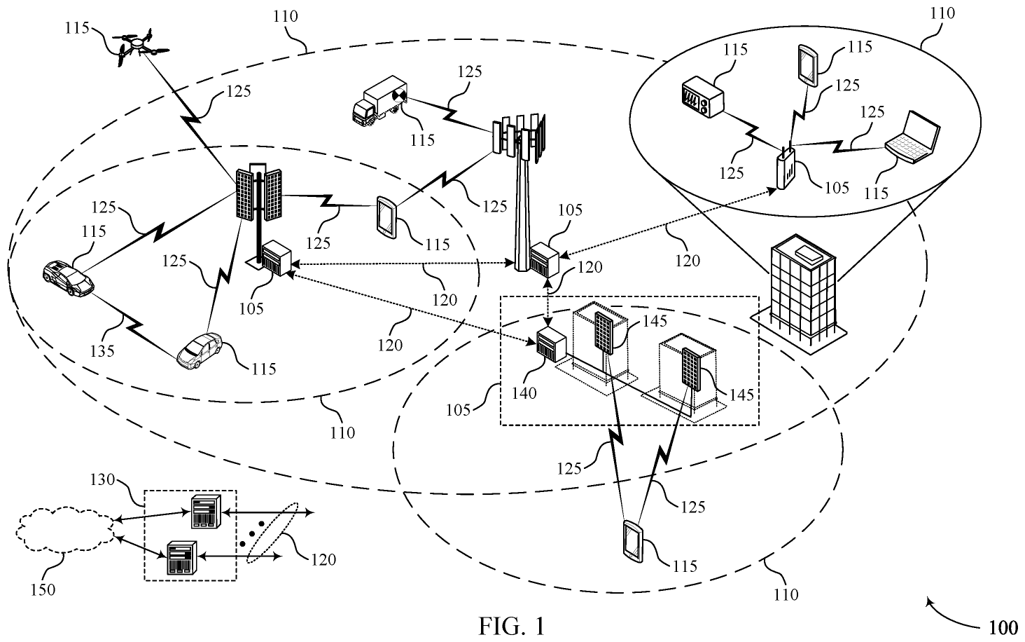

FIG. 1 illustrates an example of a wireless communications system 100 that supports intra-band CA/DC in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using CA or multi-carrier operation. A UE 115 may be configured with multiple downlink component carriers and one or more uplink component carriers according to a CA configuration. CA may be used with both frequency division duplexing (FDD) and time division duplexing (TDD) component carriers.

In some examples (e.g., in a CA configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a CA configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may identify a set of carriers within a frequency band for communicating with a base station 105 via either CA or DC. The UE 115 may determine that a first parameter for communications over a first carrier exceeds a threshold with respect to corresponding parameters of other carriers, the first parameter being either a downlink reception parameter or an uplink transmission parameter. The UE 115 may refrain from communicating over the first carrier based at least in part on the first parameter exceeding the threshold.

A base station 105 may identify, for a UE, a set of carriers within a frequency band for communicating with the UE via either CA or DC. The base station 105 may determine, for each carrier in the set of carriers, a parameter for communications over the carrier within the frequency band, the parameter being either a downlink reception parameter or an uplink transmission parameter. The base station 105 may determine a threshold with respect to the parameter associated with each carrier of the set of carriers. The base station 105 may schedule communications with the UE 115 based at least in part on the parameter with respect to the carriers in the set of carriers satisfying the threshold.

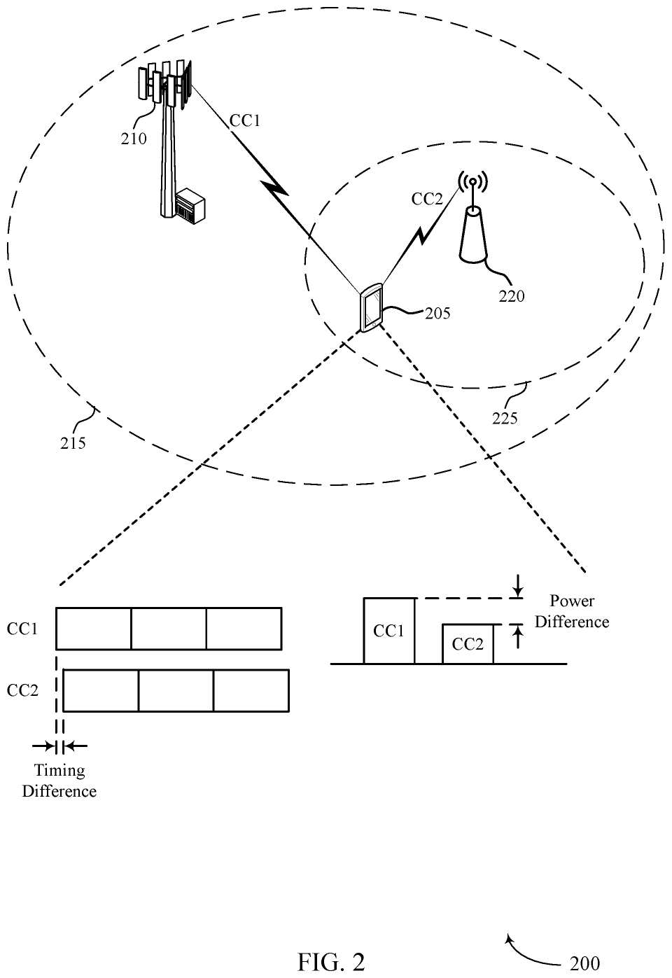

FIG. 2 illustrates an example of a wireless communication system 200 that supports intra-band CA/DC in accordance with aspects of the present disclosure. Wireless communication system 200 may implement aspects of wireless communication system 100. Wireless communication system 200 may include UE 205, base station 210 having a coverage area 215, and base station 220 having a coverage area 225, which may be examples of corresponding devices described herein. In some aspects, base station 210 and base station 220 may be performing intra-band communications with UE 205 utilizing CA and/or DC techniques. Base station 210 and/or base station 220 may be the same type of base station or may be different types of base stations (e.g., may be conventional base stations, TRPs, cells, and the like). In some aspects, base station 210 and base station 220 may, in some example, refer to different antennas of the same base station (e.g., non-co-located antennas).

Broadly, CA and/or DC communication techniques typically involve each base station performing downlink and/or uplink communications with UE 205 using its corresponding carrier. For example, base station 210 may be performing CA and/or DC communications with UE 205 using a first carrier (e.g., CC1) and base station 220 may be performing CA and/or DC communications with UE 205 using a second carrier (e.g., CC2). The first carrier and second carrier may be within the same frequency band (e.g., intra-band). Conventional CA/DC techniques typically assume co-location between base station 210 and base station 220 (e.g., assume that each base station is located at least somewhat the same distance from UE 205).

Co-location between the base stations typically means that the propagation delays (e.g., timing delays) and/or transmit/receive power levels used for communications between UE 205 and base station 210 and between UE 205 and base station 220 are relatively small (e.g., within the CP length, similar transmit/receive power levels, etc.). For example, for downlink communications such conventional intra-band NR-CA and/or intra-band synchronous DC techniques define a maximum receive timing difference (MRTD) for the communications using the intra-band carriers. In some aspects, the MRTD for intra-band NR-CA and intra-band synchronous DC communication techniques is generally defined as 3 μs for FR1. As discussed, this assumes co-location between the base stations. The 3 μs MRTD is generally smaller than the CP length for a SCS of 15 kHz (e.g., for FR1). For uplink communications, a maximum transmit timing difference (MTTD) for intra-band CA/DC communications is also defined (e.g., 5.21 μs).

However, in some examples wireless communication system 200 may operate in other frequency ranges (e.g., FR2, FR3, etc.). Moreover, in some deployment scenarios the base stations may be non-co-located with respect to each other. That is, the distance between UE 205 and base station 210 may be quite a bit different than the distance between UE 205 and base station 220. Accordingly, the propagation differences between each base station and UE 205 may increase beyond the CP length. For example, the MRTD for downlink communications may be extended from 3 μs to a higher value (e.g., 33 μs) to support CA/DC communications. For uplink communications, the MTTD may be extended from 5.21 μs to a higher value (e.g., 35.21 μs) to support CA/DC communications. Furthermore and for downlink communications, the cells within the frequency band (e.g., base station 210 and base station 220) may have a larger receive power difference due to the cells being non-co-located. Since the same low noise amplifier (LNA) of UE 205 may be used for the cells within the frequency band and, at least in some instances, fast Fourier transform (FFT) timing may be shared for the cells, the timing differences and/or power imbalance between the different cells may cause a performance degradation for the intra-band CA/DC communications.

In the uplink scenario, the uplink carriers in the frequency band may also have a larger transmit power difference due to the non-co-location deployment. Similarly, since the same power amplifier (PA) may be used for the cells in the frequency band and the FFT timing may be shared for the cells, the timing difference and/or power imbalance between the different uplink carriers may also cause performance degradation for the intra-band CA/DC communications between UE 205 and base station 210 and/or UE 205 and base station 220. Accordingly, intra-band CA/DC communications between UE 205 and base station 210 and/or base station 220 may experience performance degradation in the non-co-located deployment scenario based on the timing differences and/or power differences between the different base stations from the perspective of UE 205.

Accordingly, aspects of the described techniques provide various mechanisms adopted by UE 205, base station 210, and/or a base station 220 to identify or otherwise determine the set of carriers within a frequency band (e.g., the intra-band carriers associated with each base station). As discussed, the set of carriers may be used for communications with UE 205 via CA and/or DC communication techniques. In the non-limiting example illustrated in FIG. 2, the set of carriers includes a first carrier (e.g., CC1) associated with communications between base station 210 and UE 205 and a second carrier (e.g., CC2) associated with communications between base station 220 and UE 205. UE 205 may identify or otherwise determine that a first parameter for communications over a first carrier exceeds a threshold with respect to the corresponding parameter of the other carriers. UE 205 may refrain from communicating using the first carrier in response to the first parameter exceeding the threshold. For example and in the downlink scenario, this may include UE 205 refraining from monitoring for a downlink reception on the first carrier. An example in the uplink scenario may include UE 205 refraining from performing an uplink transmission on the first carrier. In some examples, the refraining may include UE 205, base station 210, and/or base station 220 configuring or otherwise adopting a different MCS, aggregation level, and the like, based on the first parameter exceeding the threshold.

In some aspects, the first parameter may be either a downlink reception parameter or an uplink transmission parameter. Broadly, the first parameter may correspond to a timing difference (e.g., downlink receive and/or uplink transmission timing) and/or a power difference (e.g., downlink receive power and/or uplink transmit power) between the carriers. For example, the first parameter may be the downlink receive timing of one carrier with respect to the other carriers. That is, a signal transmitted on the first carrier from base station 210 to UE 205 and a signal transmitted on the second carrier from base station 220 to UE 205 may not arrive at the same time at UE 205 (e.g., due to the non-co-location deployment example where one base station is farther from UE 205 than the other base station). UE 205 may measure the downlink receive timing difference between the first carrier and the second carrier as the first parameter. In another example, the signal transmitted on the first carrier from base station 210 to UE 205 may be received by UE 205 at different power levels (e.g., due to the non-co-location deployment example). UE 205 may measure the receive power for each carrier and determine the first parameter based on the difference in receive power from the first carrier to the second carrier, or vice versa.

UE 205 may compare the first parameter to the threshold to determine whether the first parameter exceeds the threshold. In some examples, the threshold may correspond to the downlink receive timing difference (e.g., MTRD), a downlink receive power difference, an uplink transmit timing difference (e.g., MTTD), an uplink transmit power difference, and the like. Accordingly, comparing the measured timing difference and/or power difference between the first carrier and the second carrier may indicate whether the first parameter exceeds a threshold. Identifying or otherwise determining that the first parameter exceeds a threshold may enable UE 205 to refrain from communications using the first carrier (e.g., to avoid or mitigate communication degradation).

Moreover, base station 210 and/or base station 220 (e.g., any base station associated with the intra-band set of carriers used for CA/DC communications with UE 205) may also support scheduling decisions to avoid the first parameter exceeding the threshold. For example, base station 210 and/or base station 220 may identify or otherwise determine the set of intra-band carriers being used for CA/DC communications with UE 205. For example, base station 210 and base station 220 may identify or otherwise determine the first carrier used for communications with UE 205 by base station 210 and the second carrier used for communications with UE 205 by base station 220. Base station 210 and/or base station 220 may also identify or otherwise determine the parameters for each carrier (e.g., the first parameter, which may correspond to a downlink reception parameter and/or an uplink transmission parameter). Base station 210 and/or base station 220 may also identify or otherwise determine the threshold with respect to the parameter for each carrier.

That is, base station 210 and/or base station 220 may determine that the intra-band CA/DC communications with UE 205 involves non-co-located base stations such that the timing differences and/or power differences between the first carrier and the second carrier could potentially exceed the threshold. For example, UE 205 may have previously transmitted or otherwise provided a message indicating the first parameter discussed above. For example, UE 205 may transmit or otherwise provide a message (e.g., a UE capability message, a request for assistance message, or other uplink message) indicating the threshold supported a UE 205 for intra-band CA/DC communications. The uplink message may be any PUCCH message, PUSCH message, a MAC CE, and the like, that is transmitted periodically and/or aperiodically. In some aspects, the report/message may be triggered by an event, such as UE 205 determining that a maximum transmit timing difference of two uplink carriers within a frequency band exceeds a certain value. In the case of intra-band DC where the two uplink carriers belong to different cell-groups, the message may be reported to either or both of the cell-groups. In some aspects, the report/message may be triggered by an event such as UE 205 determining that the transmit power difference of two uplink carriers within a frequency band exceeds a certain value. In case of intra-band DC where the two downlink cells belong to different cell-groups, the message may be reported to either or both of the cell-groups.

Base station 210 and/or base station 220 may schedule communications with UE 205, at least to some degree, based on the parameter with respect to each carrier satisfying the threshold. For example, base station 210 and/or base station 220 may adjust or otherwise modify transmit timing and/or power for downlink transmissions to UE 205, uplink transmit timing and/or power for uplink transmissions from UE 205, and/or other parameters associated with the intra-band CA/DC communications.

More particularly and in the downlink scenario, this may include base station 210 and/or base station 220 refraining from scheduling downlink transmissions to UE 205 on a carrier based on the MRTD of the downlink transmission exceeding the threshold with respect to downlink transmissions to UE 205 over other carriers in the set of intra-band carriers. In another example in the downlink scenario, this may include base station 210 and/or base station 220 refraining from scheduling a downlink transmission to UE 205 on a carrier based on the maximum receive power difference of the downlink transmission exceeding the threshold with respect to downlink transmissions to UE 205 over the other carriers in the set of intra-band carriers.

Accordingly and in the downlink scenario, for intra-band CA/DC communications with UE 205, base station 210 and/or base station 220 may schedule or configure a downlink communication for UE 205 to reduce or mitigate a performance degradation of the downlink reception. This may be based on a receive timing difference exceeding X μs (e.g., X=3) and/or based on the receive power difference exceeding Y dB (e.g., Y=6). The receive power in this instance may correspond to the measured receive power of the downlink transmission, the received power of spectral density (PSD), the ratio of the receive power per resource block (Rx power/RB), the ratio of receive power per hertz (Rx power/Hz), and the like. When the receive timing difference between two cells (e.g., base station 210 and base station 220) exceeds X microseconds and UE 205 determines a timing for its LNA adjustment based on a first downlink cell from the two downlink cells, the scheduler may avoid scheduling downlink reception on the second downlink cell during the period where UE 205 adjusts its LNA (e.g., when UE 205 would refrain from monitoring the carrier due to the first parameter exceeding a threshold). In some examples, this may include the scheduler of base station 210 and/or base station 220 scheduling downlink receptions on the second downlink cell during the period using a lower MC S/code rate, a higher the aggregation level, and the like.

Similarly, when the difference in the receive power to downlink cells exceeds Y dB, the scheduler may avoid scheduling a downlink reception on the second downlink cell that has a lower receive power than the first downlink cell. The scheduler may also schedule the downlink reception on the second downlink cell during the period and using a lower MC S/coding rate, the higher the aggregation level, and the like.

In the uplink scenario, this may include base station 210 and/or base station 220 refraining from scheduling an uplink transmission from UE 205 on a carrier based on the MTTD of the uplink transmission exceeding the threshold with respect to uplink transmissions from UE 205 over the other carriers in the set of intra-band carriers. In another example in the uplink scenario, this may include base station 210 and/or base station 220 refraining from scheduling an uplink transmission from UE 205 on a carrier based on a maximum receive power difference of the uplink transmission exceeding a threshold with respect to a receive power of uplink transmissions from UE 205 over the other carriers in the set of intra-band carriers.

Accordingly and in the uplink example for intra-band CA/DC communications, base station 210 and/or base station 220 may schedule or configure an uplink transmission from UE 205 to avoid or mitigate performance degradation in the uplink transmission based on the parameter and the threshold. For example, base station 210 and/or base station 220 may schedule or configure the uplink transmission from UE 205 if the transmit timing difference exceeds X microseconds (e.g., X=3) and/or if the difference in transmit/receive power exceeds Y dB (e.g., Y=6). The transmit power in this example may correspond to the transmit power used by UE 205 for the uplink transmission, the transmit PSD, the ratio of transmit power per resource block (e.g., Tx power/RB), the ratio of transmit power per hertz (e.g., Tx power/Hz), and the like. When the transmit timing difference of two uplink carriers exceeds X microseconds and UE 205 determines a timing for PA adjustments based on the first uplink carrier, the scheduler of base station 210 and/or base station 220 may avoid scheduling an uplink transmission on the second carrier during the period where UE 205 adjusts its PA. In another example the scheduler may schedule the uplink transmission on the second uplink carrier during the period and using a lower MCS/code rate, the higher aggregation level, and the like. When the difference in transmit power of two uplink carriers exceeds Y dB, the scheduler may avoid scheduling an uplink transmission on the second uplink carrier that has a lower transmit power than the first uplink carrier, or vice versa. The schedule may also schedule an uplink transmission on the second uplink carrier during a period and using a lower MCS/code rate, the higher aggregation level, and the like.

As discussed above, UE 205 may identify or otherwise refrain from communicating on a carrier associated with the first parameter exceeding the threshold. The refraining may be done for a time period. For example, UE 205 may identify or otherwise determine the time period for refraining from communicating over the first carrier based on the timing difference and/or power difference exceeding the threshold. In some example, the time period may be based on another communication on the other carrier. For example, the time period may be based on a downlink reception over the other carrier(s) and/or an uplink transmission over the other carrier(s). In some aspects, this may include UE 205 transmitting a message indicating the UE capability information for supporting communications using the set of intra-band carriers and CA/DC communications. The time period for refraining from communicating may be for one or more symbols, slots, transmission opportunities, and the like.

Broadly, the carrier that UE 205 chooses to communicate on and which carrier UE 205 chooses to refrain from communicating on may be based on the type of cell associated with each carrier (e.g., PCell vs. non-PCell), the timing of the communications being performed on each carrier, and the like. Accordingly, in some examples UE 205 may identify or otherwise determine that the first carrier is associated with a non-primary cell associated with UE 205. In this example, UE 205 may refrain from communicating on the first carrier based on the first carrier being associated with a non-primary cell (e.g., a SCell). That is, UE 205 may select (e.g., favor) the PCell carrier for communicating on using the set of intra-band carriers. This may improve reliability for the intra-band CA/DC communications.

In some examples UE 205 may identify or otherwise determine that a first downlink reception over the first carrier begins after a second downlink reception over a second carrier of the set of carriers. In this example, the refraining may be based on the first downlink reception beginning after the second downlink reception. Moreover, in this example the first parameter may be based at least in part on a timing difference between the first downlink reception and the second downlink reception. Accordingly, UE 205 may, between two downlink cells with a receive timing differential greater than X microseconds, select the downlink cell with the earliest downlink reception (e.g., to improve processing causality).

In some examples, UE 205 may identify or otherwise determine that a first downlink reception over the first carrier begins before a second downlink reception over a second carrier of the set of carriers. In this example, the refraining may be based on the first downlink reception beginning before the second downlink reception. Moreover, in this example the first parameter may be based at least in part on a timing difference between the first downlink reception and the second downlink reception. Accordingly, UE 205 may, between two downlink cells with a receive timing differential greater than X microseconds, select the downlink cell with the latest downlink reception.

In some examples, UE 205 may identify or otherwise determine that a first receive power associated with the first carrier is lower than a second receive power level associated with a second carrier of the set of carriers. In this example, the refraining may be based on the first receive power being lower than the second receive power. Moreover, the first parameter may be based at least in part on a receive power difference between the first receive power and the second receive power. Accordingly, UE 205 may, between two downlink cells with a receive timing differential greater than X microseconds, select the downlink cell with the higher receive power.

In some examples UE 205 may identify or otherwise determine that the first carrier is associated with a non-primary cell associated with UE 205. In this example, UE 205 may refrain from communicating on the first carrier based on the first carrier being associated with a non-primary cell (e.g., a SCell). Accordingly, UE 205 may, for PCell or PSCell in the frequency band, chose the carrier associated with the PCell/PSCell. If neither the PCell or PSCell are configured within the frequency band, UE 205 may give preference to the SCell associated with the lowest cell index value.

In some examples UE 205 may identify or otherwise determine that a first uplink transmission over the first carrier begins after a second uplink transmission over the second carrier of the set of carriers. In this example, the refraining may be based on the first uplink transmission beginning after the second uplink transmission. Moreover, in this example the first parameter may be based at least in part on a timing difference between the first uplink transmission and the second uplink transmission. Accordingly, UE 205 may, between two uplink cells with a receive timing differential greater than X microseconds, select the uplink cell with the earliest uplink transmission.

In some examples, UE 205 may identify or otherwise determine that a first uplink transmission over the first carrier begins before a second uplink transmission over a second carrier of the set of carriers. In this example, the refraining may be based on the first uplink transmission beginning before the second uplink transmission. Moreover, in this example the first parameter may be based at least in part on a timing difference between the first uplink transmission and the second uplink transmission. Accordingly, UE 205 may, between two uplink cells with a receive timing differential greater than X microseconds, select the uplink cell with the latest uplink transmission.

In some examples, UE 205 may identify or otherwise determine that a first receive power associated with the first carrier is lower than a second receive power level associated with a second carrier of the set of carriers. In this example, the refraining may be based on the first receive power being lower than the second receive power. Moreover, the first parameter may be based at least in part on a receive power difference between the first receive power and the second receive power. Accordingly, UE 205 may, between two uplink cells with a receive timing differential greater than X microseconds, select the uplink cell with the higher receive power.

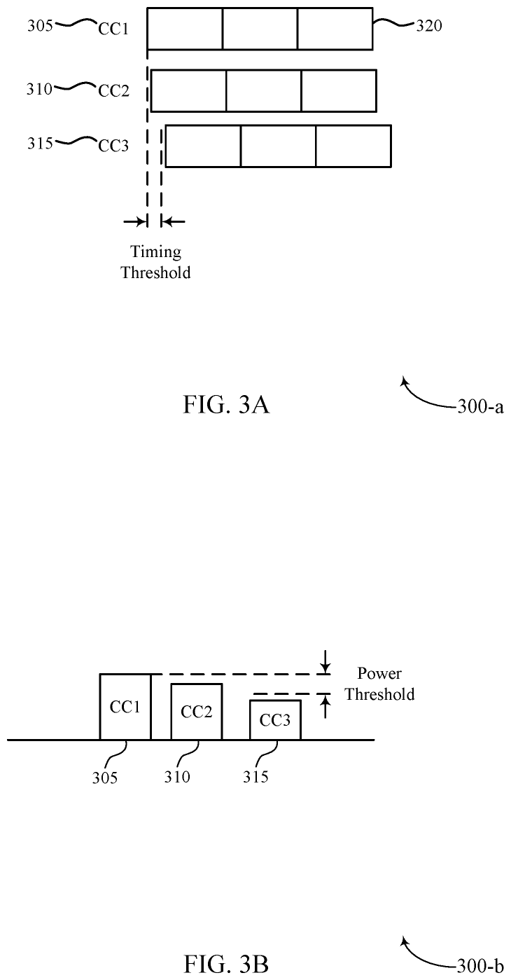

FIGS. 3A and 3B illustrate examples of a carrier configuration 300 that supports intra-band CA/DC in accordance with aspects of the present disclosure. Carrier configuration 300 may implement aspects of wireless communication systems 100 and/or 200. Aspects of carrier configuration 300 may be implemented at or implemented by a UE and/or base station, which may be examples of the corresponding devices described herein. Broadly, carrier configuration 300-a of FIG. 3A illustrates an example timing threshold between a set of intra-band carriers used for CA/DC communications and carrier configuration 300-b of FIG. 3B illustrates an example power threshold between the set of intra-band carriers.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier 305 (e.g., CC1), a second carrier 310 (e.g., CC2), and a third carrier 315 (e.g., CC3) used for the CA/DC communications during one or more slots 320. However, it is to be understood that the set of intra-band carriers may include more or less than the three carriers illustrated in FIG. 3.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier. For example, the UE may refrain from monitoring for a downlink reception on the first carrier in the downlink scenario and/or may refrain from performing an uplink transmission on the first carrier in an uplink scenario.

More particularly and for the downlink scenario, this may include the UE determining a downlink receive timing for each carrier in the set of intra-band carriers. The UE may identify or otherwise determine that a downlink receive timing difference associated with the first carrier with respect to other carriers exceeds a threshold (e.g., the MTRD). In this context, the first parameter may correspond to the downlink receive timing of each carrier. In the non-limiting example illustrated in carrier configuration 300-a of FIG. 3A, the threshold may correspond to the timing threshold (e.g., MRTD) and the UE may determine that the downlink receive timing for the first carrier 305 and the second carrier 310 both satisfy the threshold. However, the downlink receive timing of the third carrier 315 exceeds the threshold (e.g., the receive timing difference of the third carrier 315 with respect to the other carriers exceeds X microseconds (e.g., X=3)). Accordingly, the UE may refrain from communicating using the third carrier 315 (in this example) based on its downlink receive timing difference between the carriers exceeding the threshold.

In the non-limiting example illustrated in carrier configuration 300-b of FIG. 3B, the threshold may correspond to a power threshold. For example, the UE may identify, measure, or otherwise determine the receive power for each carrier in the set of carriers. The UE may identify or otherwise determine that a downlink receive power difference associated with the first carrier with respect to the other carriers exceeds the threshold. In the non-limiting example illustrated in FIG. 3B, this may include the UE determining that the receive power of the first carrier 305 and the receive power of the second carrier 310 satisfy the threshold. However, the UE may identify or otherwise determine that the receive power of the third carrier 315 exceeds a threshold (such as the difference in the receive power, the Rx PSD, the Rx power/RB, the Rx power/Hz, etc.) exceeds Y dB (e.g., Y=6)). Accordingly, the UE may refrain from communicating using the third carrier 315 (in this example) based on its receive power exceeding the power threshold (e.g., with respect to the received power of the other carriers).

In some aspects, if the UE receives on the first carrier 305 and the second carrier 310, the UE may not receive on the third carrier 315. Conversely, if the UE receives on the third carrier 315, the UE may not receive on the first carrier 305 and/or the second carrier 310. That is, the UE may select the carrier(s) associated with the first parameter exceeding the threshold to use for CA/DC communications rather than the carrier(s) that satisfy the threshold.

In the uplink example, this may include the UE identifying or otherwise determining an uplink transmission timing for each carrier in the set of intra-band carriers. Based on the uplink transmission timing for each carrier, the UE may identify or otherwise determine that an uplink transmit timing difference associated with the first carrier 305 with respect to the other carriers exceeds the threshold (e.g., MTTD). The first parameter in this context may correspond to the uplink transmit timing associated with each carrier. In a non-limiting example illustrated in carrier configuration 300-a of FIG. 3A, this may include the UE determining that the uplink transmit timing using the first carrier 305 and the second carrier 310 satisfy the threshold. However, the UE may determine that the uplink transmit timing using the third carrier 315 exceeds a threshold (e.g., the transmit timing difference exceeds X μs (X=5.21)). Accordingly, the UE may refrain from performing an uplink transmission using the third carrier 315 (in this example) based on its uplink transmit timing exceeding the threshold with respect to the uplink transmit timing of the other carriers.

In the non-limiting example illustrated in carrier configuration 300-b of FIG. 3B, the threshold may correspond to the power threshold. The UE may identify or otherwise determine an uplink transmit power for ach carrier in the set of intra-band carriers. Based on the uplink transmit power of each carrier, the UE may identify or otherwise determine that an uplink transmit power difference associated with the first carrier exceeds the threshold with respect to the other carriers. The first parameter in this context may correspond to the uplink transmit power. In the non-limiting example illustrated in carrier configuration 300-b of FIG. 3B, the UE may determine that the uplink transmit power of the first carrier 305 and the second carrier 310 satisfy the threshold. However, the UE may identify or otherwise determine that the uplink transmit power of the third carrier 315 exceeds the threshold (e.g., the different in transmit power, the difference in transmit power spectral density, the ratio of Tx power/RB, the ratio of Tx power/Hz, etc., exceeds Y dB (e.g., Y=6)). Accordingly, the UE may refrain from communicating using the third carrier 315 (in this example) based on its uplink transmit power exceeding the power threshold (e.g., with respect to the uplink transmit power of the other carriers).

In some aspects, if the UE transmits on the first carrier 305 and the second carrier 310, the UE may not transmit on the third carrier 315. Conversely, if the UE transmits on the third carrier 315, the UE may not transmit on the first carrier 305 and/or the second carrier 310. That is, the UE may select the carrier(s) associated with the first parameter exceeding the threshold to use for CA/DC communications rather than the carrier(s) that satisfy the threshold.

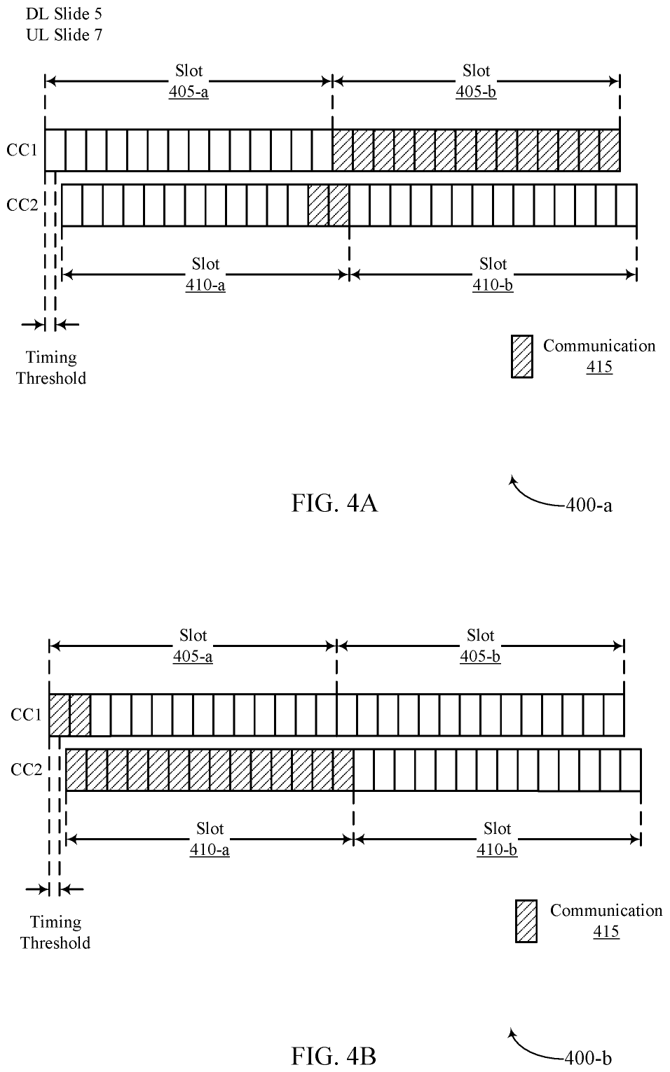

FIGS. 4A and 4B illustrate examples of a carrier configuration 400 that supports intra-band CA/DC in accordance with aspects of the present disclosure. Carrier configuration 400 may implement aspects of wireless communication systems 100 and/or 200 and/or carrier configuration 300. Aspects of carrier configuration 400 may be implemented at or implemented by a UE and/or base station, which may be examples of the corresponding devices described herein. Broadly, carrier configuration 400-a of FIG. 4A illustrates an example timing threshold between a set of intra-band carriers used for CA/DC communications and carrier configuration 400-b of FIG. 4B illustrates a different example timing threshold between the set of intra-band carriers.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier (e.g., CC1) used for CA/DC communications during one or more slots 405 and a second carrier (e.g., CC2) used for the CA/DC communications during one or more slots 410. However, it is to be understood that the set of intra-band carriers may include more or less than the two carriers illustrated in FIG. 4.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier. For example, the UE may refrain from monitoring for a downlink reception on the first carrier in the downlink scenario and/or may refrain from performing an uplink transmission on the first carrier in an uplink scenario.

In the downlink scenario example, for intra-band CA/DC communications, if the receive timing difference between two downlink cells (e.g., base stations, cells, TRPs, etc.) exceeds X microseconds, the UE adjusts its LNA (e.g., turns off or down) based on the timing for receiving a downlink reception on either of the two downlink cells. This may generally create a time period where the UE cannot receive downlink signals/channels on the other downlink cell with sufficient quality. Carrier configuration 400-a of FIG. 4A illustrates a nonlimiting example where the two downlink cells with a receive timing difference greater than X microseconds is a couple of symbols. That is the UE may identify, measure, or otherwise determine that the receive timing of the second carrier exceeds the MRTD during slots 410. The UE may identify or otherwise determine that it is scheduled for communication 415 (e.g., a downlink reception in this example) during the last two symbols of slot 410-a on the second carrier. The UE may also determine that it is scheduled for communications 415 (e.g., another downlink reception in this example) during each symbol of slot 410-b on the first carrier. In this example, the UE may choose to refrain from communicating on the first carrier or the second carrier (e.g., based on the downlink reception on the other carriers). That is, if the UE determines to receive the downlink reception during slot 405-b on the first carrier, the UE may create a time period of a couple symbols during which it refrains from communicating on the second carrier. During this time period, the UE may not receive the communication 415 on the second carrier during the last two symbols of slot 410-a.

Continuing with the downlink scenario, carrier configuration 400-b of FIG. 4B illustrates a nonlimiting example where the two downlink cells with a receive timing difference greater than X microseconds is a couple of symbols. That is the UE may identify, measure, or otherwise determine that the receive timing of the second carrier exceeds the MRTD during slots 410. The UE may identify or otherwise determine that it is scheduled for communication 415 (e.g., a downlink reception in this example) during the first two symbols of slot 405-a on the first carrier. The UE may also determine that it is scheduled for communications 415 (e.g., another downlink reception in this example) during each symbol of slot 410-a on the second carrier. In this example, the UE may choose to refrain from communicating on the first carrier or the second carrier (e.g., based on the downlink reception on the other carriers). That is, if the UE determines to receive the downlink reception during slot 410-a on the second carrier, the UE may create a time period of a couple symbols during which it refrains from communicating on the first carrier. During this time period, the UE may not receive the communication 415 on the first carrier during the first two symbols of slot 405-a.

In the uplink scenario example, for intra-band CA/DC communications, if the transmit timing difference between two uplink cells (e.g., base stations, cells, TRPs, etc.) exceeds X microseconds, the UE adjusts its PA (e.g., turns off) based on the timing for performing an uplink transmission on either of the two uplink cells. This may generally create a time period where the UE cannot transmit uplink signals/channels on the other uplink cell with sufficient quality. Carrier configuration 400-a of FIG. 4A illustrates a nonlimiting example where the two uplink cells with a transmit timing difference greater than X microseconds is a couple of symbols. That is the UE may identify, measure, or otherwise determine that the transmit timing of the second carrier exceeds the MTTD during slots 410. The UE may identify or otherwise determine that it is scheduled for communication 415 (e.g., an uplink transmission in this example) during the last two symbols of slot 410-a on the second carrier. The UE may also determine that it is scheduled for communications 415 (e.g., another uplink transmission in this example) during each symbol of slot 405-b on the first carrier. In this example, the UE may choose to refrain from communicating on the first carrier or the second carrier (e.g., based on the uplink transmission on the other carriers). That is, if the UE determines to perform the uplink transmission during slot 405-b on the first carrier, the UE may create a time period of a couple symbols during which it refrains from communicating on the second carrier. During this time period, the UE may not perform the communication 415 on the second carrier during the last two symbols of slot 410-a.

Continuing with the uplink scenario, carrier configuration 400-b of FIG. 4B illustrates a nonlimiting example where the two uplink cells with a transmit timing difference greater than X microseconds is a couple of symbols. That is the UE may identify, measure, or otherwise determine that the transmit timing of the second carrier exceeds the MTTD during slots 410. The UE may identify or otherwise determine that it is scheduled for communication 415 (e.g., an uplink transmission in this example) during the first two symbols of slot 405-a on the first carrier. The UE may also determine that it is scheduled for communications 415 (e.g., another uplink transmission in this example) during each symbol of slot 410-a on the second carrier. In this example, the UE may choose to refrain from communicating on the first carrier or the second carrier (e.g., based on the uplink transmission on the other carriers). That is, if the UE determines to perform the uplink transmission during slot 410-a on the second carrier, the UE may create a time period of a couple symbols during which it refrains from communicating on the first carrier. During this time period, the UE may not perform the communication 415 on the first carrier during the first two symbols of slot 405-a.

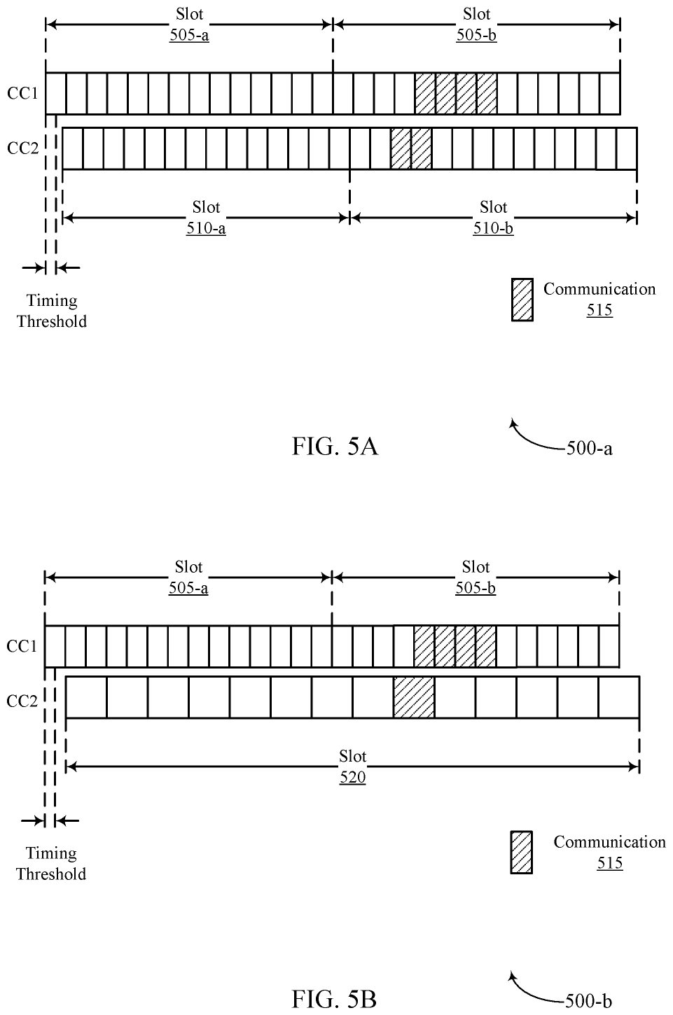

FIGS. 5A and 5B illustrate examples of a carrier configuration 500 that supports intra-band CA/DC in accordance with aspects of the present disclosure. Carrier configuration 500 may implement aspects of wireless communication systems 100 and/or 200 and/or carrier configurations 300 and/or 400. Aspects of carrier configuration 500 may be implemented at or implemented by a UE and/or base station, which may be examples of the corresponding devices described herein. Broadly, carrier configuration 500-a of FIG. 5A illustrates an example timing threshold between a set of intra-band carriers used for CA/DC communications and carrier configuration 500-b of FIG. 5B illustrates a different example timing threshold between the set of intra-band carriers.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier (e.g., CC1) used for CA/DC communications during one or more slots 505 and a second carrier (e.g., CC2) used for the CA/DC communications during one or more slots 510. However, it is to be understood that the set of intra-band carriers may include more or less than the two carriers illustrated in FIG. 5.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier. For example, the UE may refrain from monitoring for a downlink reception on the first carrier in the downlink scenario and/or may refrain from performing an uplink transmission on the first carrier in an uplink scenario.

In the downlink scenario example, for intra-band CA/DC communications, if the receive timing difference between two downlink cells (e.g., base stations, cells, TRPs, etc.) exceeds X microseconds, the UE adjusts its LNA (e.g., turns off) based on the timing for receiving a downlink reception on either of the two downlink cells. This may generally create a time period where the UE cannot receive downlink signals/channels on the other downlink cell with sufficient quality. Carrier configuration 500-a of FIG. 5A illustrates a nonlimiting example where the two downlink cells with a receive timing difference greater than X microseconds is a couple of symbols. That is the UE may identify, measure, or otherwise determine that the receive timing of the second carrier exceeds the MRTD during slots 510. The UE may identify or otherwise determine that it is scheduled for communication 515 (e.g., a downlink reception in this example) during two symbols of slot 510-b on the second carrier. The UE may also determine that it is scheduled for communications 415 (e.g., another downlink reception in this example) during a subset of the symbols of slot 505-b on the first carrier. In this example, the UE may choose to refrain from communicating on the first carrier or the second carrier (e.g., based on the downlink reception on the other carriers). That is, if the UE determines to receive the downlink reception during slot 405-b on the first carrier, the UE may create a time period of a couple symbols during which it refrains from communicating on the second carrier. During this time period, the UE may not receive the communication 515 on the second carrier during the two symbols of slot 510-b. Accordingly, the downlink reception can span only part of the slot 505/510 or for multiple slots 505/510.

Continuing with the downlink scenario, carrier configuration 500-b of FIG. 5B illustrates a nonlimiting example where the two downlink cells with a receive timing difference greater than X microseconds is a couple of symbols. In some aspects, the downlink cells may be associated with different downlink SCSs (e.g., each carrier may use a different SCS). The UE may identify, measure, or otherwise determine that the receive timing of the second carrier exceeds the MRTD during slots 510. The UE may identify or otherwise determine that it is scheduled for communication 515 (e.g., a downlink reception in this example) during a subset of the symbols of slot 405-b on the first carrier. The UE may also determine that it is scheduled for communications 415 (e.g., another downlink reception in this example) during one symbol of slot 510-b on the second carrier. In this example, the UE may choose to refrain from communicating on the first carrier or the second carrier (e.g., based on the downlink reception on the other carriers). That is, if the UE determines to receive the downlink reception during slot 505-b on the first carrier, the UE may create a time period of a couple symbols (one symbol on the second carrier SCS) during which it refrains from communicating on the second carrier. During this time period, the UE may not receive the communication 515 on the second carrier during the symbol of slot 505-b.

In the uplink scenario example, for intra-band CA/DC communications, if the transmit timing difference between two uplink cells (e.g., base stations, cells, TRPs, etc.) exceeds X microseconds, the UE adjusts its PA (e.g., turns off) based on the timing for performing an uplink transmission on either of the two uplink cells. This may generally create a time period where the UE cannot transmit uplink signals/channels on the other uplink cell with sufficient quality. Carrier configuration 500-a of FIG. 5A illustrates a nonlimiting example where the two uplink cells with a transmit timing difference greater than X microseconds is a couple of symbols. That is the UE may identify, measure, or otherwise determine that the transmit timing of the second carrier exceeds the MTTD during slots 510. The UE may identify or otherwise determine that it is scheduled for communication 515 (e.g., an uplink transmission in this example) during a symbol of slot 510-b on the second carrier. The UE may also determine that it is scheduled for communications 515 (e.g., another uplink transmission in this example) during a subset of symbols of slot 505-b on the first carrier. In this example, the UE may choose to refrain from communicating on the first carrier or the second carrier (e.g., based on the uplink transmission on the other carriers). That is, if the UE determines to perform the uplink transmission during slot 505-b on the first carrier, the UE may create a time period of a couple symbols during which it refrains from communicating on the second carrier. During this time period, the UE may not perform the communication 515 on the second carrier during the two symbols of slot 510-b.

Continuing with the uplink scenario, carrier configuration 500-b of FIG. 5B illustrates a nonlimiting example where the two uplink cells with a transmit timing difference greater than X microseconds is a couple of symbols. In some aspects, the uplink cells may be associated with different uplink SCSs (e.g., each carrier may use a different SCS). The UE may identify, measure, or otherwise determine that the transmit timing of the second carrier exceeds the MTTD during slots 510. The UE may identify or otherwise determine that it is scheduled for communication 515 (e.g., an uplink transmission in this example) during a subset of symbols of slot 505-b on the first carrier. The UE may also determine that it is scheduled for communications 515 (e.g., another uplink transmission in this example) during a symbol of slot 510-b on the second carrier. In this example, the UE may choose to refrain from communicating on the first carrier or the second carrier (e.g., based on the uplink transmission on the other carriers). That is, if the UE determines to perform the uplink transmission during slot 510-b on the second carrier, the UE may create a time period of a subset of symbols during which it refrains from communicating on the first carrier. During this time period, the UE may not perform the communication 515 on the first carrier during the subset of symbols of slot 505-b.

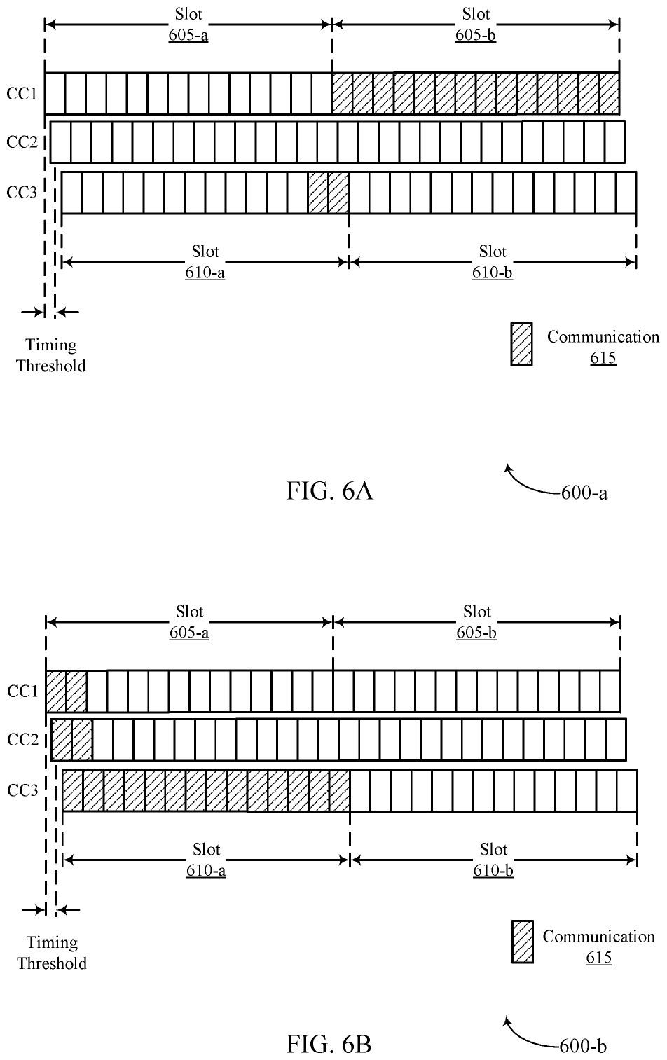

FIGS. 6A and 6B illustrate examples of a carrier configuration 600 that supports intra-band CA/DC in accordance with aspects of the present disclosure. Carrier configuration 600 may implement aspects of wireless communication systems 100 and/or 200 and/or carrier configurations 300, 400, and/or 500. Aspects of carrier configuration 600 may be implemented at or implemented by a UE and/or base station, which may be examples of the corresponding devices described herein. Broadly, carrier configuration 600-a of FIG. 6A illustrates an example timing threshold between a set of intra-band carriers used for CA/DC communications and carrier configuration 600-b of FIG. 6B illustrates a different example timing threshold between the set of intra-band carriers.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier (e.g., CC1) used for CA/DC communications during one or more slots 605, a second carrier (e.g., CC2) used for the CA/DC communications during one or more slots (not labeled for ease of reference), and a third carrier (e.g., CC3) during one or more slots 610. However, it is to be understood that the set of intra-band carriers may include more or less than the three carriers illustrated in FIG. 6.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier. For example, the UE may refrain from monitoring for a downlink reception on the first carrier in the downlink scenario and/or may refrain from performing an uplink transmission on the first carrier in an uplink scenario.

In the downlink scenario example, if there are more than two downlink cells (e.g., base stations, cells, TRPs, etc.) within the frequency band CA/DC communications, the UE may adjust its LNA (e.g., turn off or down) based on the timing for receiving a downlink reception on one or more of the downlink cells with a receive timing differential less than or equal to X microseconds. This may create a period where the UE does not receive a downlink reception on the downlink cells that do not satisfy the receive timing differential less than or equal to X microseconds with sufficient quality. Carrier configuration 600-a of FIG. 6A illustrates a nonlimiting example where the three downlink cells where two of the downlink cells have a receive timing difference less than or equal to X microseconds (e.g., satisfy the threshold) and one downlink cell with a receive timing difference greater than X microseconds. That is the UE may identify, measure, or otherwise determine that the receive timing of the third carrier exceeds the MRTD during slots 610. The UE may identify or otherwise determine that it is scheduled for communication 615 (e.g., a downlink reception in this example) all of the symbols of slot 605-b on the first carrier. The UE may also determine that it is scheduled for communications 615 (e.g., another downlink reception in this example) during a subset of the symbols of slot 610-a on the third carrier. The UE may not be scheduled for downlink receptions using the second carrier in this example. In this example, the UE may choose to refrain from communicating on the first carrier or the third carrier (e.g., based on the downlink reception on the other carriers). That is, if the UE determines to receive the downlink reception during slot 605-b on the first carrier, the UE may create a time period of a couple symbols during which it refrains from communicating on the third carrier. During this time period, the UE may not receive the communication 615 on the third carrier during the last two symbols of slot 610-a.

Continuing with the downlink scenario, carrier configuration 600-b of FIG. 6B illustrates a nonlimiting example where the three downlink cells are configured, with two of the downlink cells with a receive timing difference that satisfies the threshold and one downlink cell with a receive timing difference greater than X microseconds. The UE may identify, measure, or otherwise determine that the receive timing of the third carrier exceeds the MRTD during slots 610. The UE may identify or otherwise determine that it is scheduled for communication 615 (e.g., a downlink reception in this example) during the first two symbols of slot 605-a on the first carrier and during the first two symbols of the slot associated with the second carrier. The UE may also determine that it is scheduled for communications 615 (e.g., another downlink reception in this example) during all symbols of slot 610-a on the third carrier. In this example, the UE may choose to refrain from communicating on the first carrier, second carrier, and/or the third carrier (e.g., based on the downlink reception on the other carriers). That is, if the UE determines to receive the downlink receptions during slot 605-a on the first carrier and the second carrier, the UE may create a time period during which it refrains from communicating on the third carrier. During this time period, the UE may not receive the communication 615 on the third carrier during the symbols of slot 610-a. Of course, the UE may choose to refrain from communicating using the first carrier and second carrier and, instead, perform the intra-band CA/DC communications using the third carrier (e.g., based on the cell type associated with the carriers, the timing of the downlink receptions, and the like).

In the uplink scenario example, for intra-band CA/DC communications, if the transmit timing difference between three uplink cells (e.g., base stations, cells, TRPs, etc.) exceeds X microseconds, the UE adjusts its PA (e.g., turns off or turns down) based on the timing for performing an uplink transmission on one or more of the three uplink cells. This may generally create a time period where the UE cannot transmit uplink signals/channels on the other uplink cell(s) with sufficient quality. Carrier configuration 600-a of FIG. 6A illustrates a nonlimiting example where two uplink cells with a transmit timing difference less than X microseconds and one uplink cell has a transmit timing difference greater than X microseconds. That is the UE may identify, measure, or otherwise determine that the transmit timing of the third carrier exceeds the MTTD during slots 610. The UE may identify or otherwise determine that it is scheduled for communication 615 (e.g., an uplink transmission in this example) during the all symbols of slot 605-b on the first carrier. The UE may also determine that it is scheduled for communications 615 (e.g., another uplink transmission in this example) during the last two symbols of slot 610-a on the third carrier. In this example, the UE may choose to refrain from communicating on the first carrier/second carrier or the third carrier (e.g., based on the uplink transmission on the other carriers). That is, if the UE determines to perform the uplink transmissions during slot 605-b on the first carrier, the UE may create a time period during which it refrains from communicating on the third carrier. During this time period, the UE may not perform the communication 615 on the third carrier during slot 610-a. Of course, the UE may choose to perform the communication 615 on the third carrier and refrain from communicating on the first and second carriers.

Continuing with the uplink scenario, carrier configuration 600-b of FIG. 6B illustrates a nonlimiting example where the two uplink cells with a transmit timing difference that satisfies the threshold and one uplink cell with a transmit timing difference greater than X microseconds. The UE may identify, measure, or otherwise determine that the transmit timing of the third carrier exceeds the MTTD during slots 610. The UE may identify or otherwise determine that it is scheduled for communication 615 (e.g., an uplink transmission in this example) during the first two symbols of slot 605-a on the first and second carriers. The UE may also determine that it is scheduled for communications 615 (e.g., another uplink transmission in this example) during all symbols of slot 610-a on the third carrier. In this example, the UE may choose to refrain from communicating on the first carrier/second carrier or the third carrier (e.g., based on the uplink transmission on the other carriers). That is, if the UE determines to perform the uplink transmission during slot 610-a on the third carrier, the UE may create a time period during slot 605-a which it refrains from communicating on the first and second carriers. During this time period, the UE may not perform the communication 615 on the first and second carriers during the first two symbols of slot 605-a.

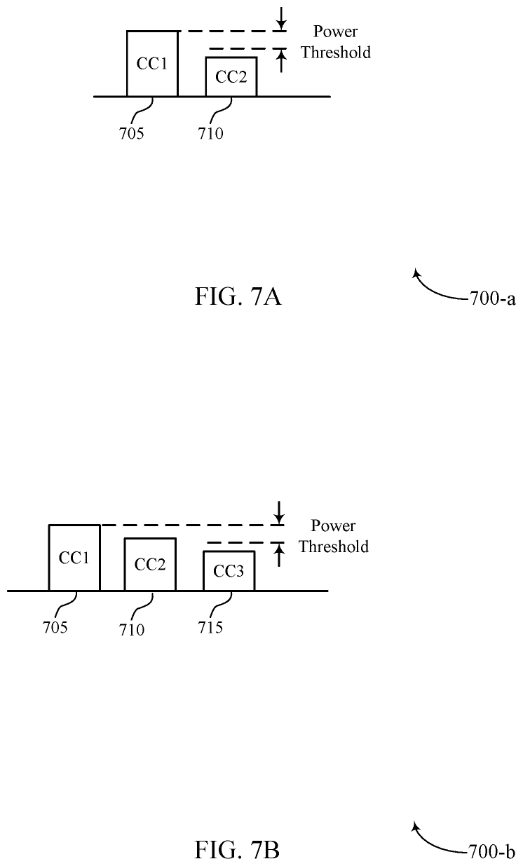

FIGS. 7A and 7B illustrate examples of a carrier configuration 700 that supports intra-band CA/DC in accordance with aspects of the present disclosure. Carrier configuration 700 may implement aspects of wireless communication systems 100 and/or 200 and/or carrier configurations 300, 400, 500, and/or 600. Aspects of carrier configuration 700 may be implemented at or implemented by a UE and/or base station, which may be examples of the corresponding devices described herein. Broadly, carrier configuration 700-a of FIG. 7A illustrates an example power threshold between a set of intra-band carriers used for CA/DC communications and carrier configuration 700-b of FIG. 7B illustrates a different example power threshold between the set of intra-band carriers.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier 705 (e.g., CC1) used for CA/DC communications and a second carrier (e.g., CC2) used for CA/DC communications. However, it is to be understood that the set of intra-band carriers may include more or less than the two carriers illustrated in FIG. 7A. The set of intra-band carrier may also correspond to the first carrier 705, the second carrier 710, and a third carrier 715 (e.g., CC3). However, it is to be understood that the set of intra-band carriers may include more or less than the three carriers illustrated in FIG. 7B.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier 705 exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier 705. For example, the UE may refrain from monitoring for a downlink reception on the first carrier 705 in the downlink scenario and/or may refrain from performing an uplink transmission on the first carrier 705 in an uplink scenario.

In the downlink scenario example, if the difference in receive power, receive PSD, receive power/RB, receive power/Hz, and the like, between two (or three) downlink cells exceeds Y dB, the UE may adjust its LNA (e.g., turn off or down) in order to receive the downlink reception on the downlink cell that has the highest receive power. This may create a period where the UE does not receive a downlink reception on the downlink cells that do not satisfy the receive power differential (e.g., with the lower receive power that exceeds the threshold). Carrier configuration 700-a of FIG. 7A illustrates a nonlimiting example where one downlink cell has a receive power greater than Y dB (e.g., satisfy the threshold) and one downlink cell has a receive power less than Y dB (e.g., fails to satisfy or otherwise exceeds the threshold). That is the UE may identify, measure, or otherwise determine that the receive power of the first carrier 705 satisfies or exceeds Y dB (e.g., satisfies the threshold) and that the receive power for the second carrier 710 fails to satisfy Y dB. In this example, the UE may choose to refrain from communicating on the second carrier 710 (e.g., based on the downlink reception on the other carriers and/or the receive power level on the second carrier 710). That is, if the UE determines to receive the downlink reception on the first carrier 705, the UE may create a time period during which it refrains from communicating on the second carrier 710. During this time period, the UE may not receive a downlink reception on the second carrier 710.

Continuing with the downlink scenario, carrier configuration 700-b of FIG. 7B illustrates a nonlimiting example where the three downlink cells are configured, with two of the downlink cells with a receive power difference that satisfies the threshold and one downlink cell with a receive power difference less than Y dB. The UE may identify, measure, or otherwise determine that the receive power of the third carrier 715 fails to satisfy the Y dB threshold. In this example, the UE may choose to refrain from communicating on third carrier 715 (e.g., based on the downlink power of the third carrier 715). That is, if the UE determines to receive the downlink receptions on the first carrier 705 and the second carrier 710, the UE may create a time period during which it refrains from communicating on the third carrier 715.

In the uplink scenario example, for intra-band CA/DC communications, if the transmit power difference between uplink cells (e.g., base stations, cells, TRPs, etc.) satisfies the Y dB threshold, the UE adjusts its PA (e.g., turns off or turns down) based on the transmit power for performing an uplink transmission on one or more of the uplink cells. This may generally create a time period where the UE cannot transmit uplink signals/channels on the other uplink cell(s) with sufficient quality. Carrier configuration 700-a of FIG. 7A illustrates a non-limiting example where two uplink cells with a transmit power difference that satisfies the threshold. That is the UE may identify, measure, or otherwise determine that the transmit power of the third carrier 715 is less than Y dB. In this example, the UE may choose to refrain from communicating on the second carrier 710 (e.g., based on the uplink transmission on the other carriers and/or the uplink transmit power). That is, if the UE determines to perform the uplink transmissions on the first carrier 705, the UE may create a time period during which it refrains from communicating on the second carrier 710.

Continuing with the uplink scenario, carrier configuration 700-b of FIG. 7B illustrates a nonlimiting example where two uplink cells with a transmit power difference that satisfies the threshold and one uplink cell with a transmit power difference that fails to satisfy the threshold (e.g., is less than Y dB). The UE may identify, measure, or otherwise determine that the transmit power of the third carrier 715 is below the Y dB. In this example, the UE may choose to refrain from communicating on the third carrier 715 (e.g., based on the uplink transmission on the other carriers and/or the uplink transmit power) and, instead, communicate on the first carrier 705 and second carrier 710. That is, if the UE determines to perform the uplink transmission on the first carrier 705 and second carrier 710, the UE may create a time period during which it refrains from communicating on the third carrier 715.

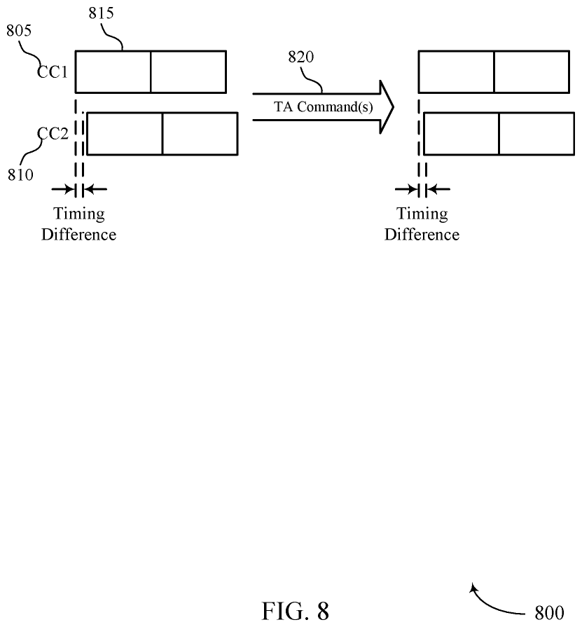

FIG. 8 illustrates an example of a carrier configuration 800 that supports intra-band CA/DC in accordance with aspects of the present disclosure. Carrier configuration 800 may implement aspects of wireless communication systems 100 and/or 200 and/or carrier configurations 300, 400, 500, 600 and/or 700. Aspects of carrier configuration 800 may be implemented at or implemented by a UE and/or base station, which may be examples of the corresponding devices described herein.

As discussed above, aspects of the described techniques provide various mechanisms for UE to avoid performance degradation in CA/DC communications using a set of intra-band carriers when the base stations are non-co-located. The set of intra-band carriers in this example may correspond to a first carrier 805 (e.g., CC1) used for CA/DC communications and a second carrier 810 (e.g., CC2) used for CA/DC communications during one or more slots 815. However, it is to be understood that the set of intra-band carriers may include more or less than the two carriers illustrated in FIG. 8.

Broadly, the UE may identify or otherwise determine the set of carriers within the frequency band (e.g., the intra-band carriers) used for communications via CA and/or DC techniques. The UE may identify, measure, or otherwise determine that a first parameter for communications over a first carrier 805 exceeds a threshold with respect to the corresponding parameter of the other carriers. As discussed, the first parameter may be either a downlink reception parameter or an uplink transmission parameter. Based on the first parameter exceeding the threshold, the UE may refrain from communicating with the first carrier 805. For example, the UE may refrain from monitoring for a downlink reception on the first carrier 805 in the downlink scenario and/or may refrain from performing an uplink transmission on the first carrier 805 in an uplink scenario.

Carrier configuration 800 illustrates an example where the first carrier 805 and second carrier 810 may belong to the same timing advance group (TAG) or to different TAGs. For intra-band CA/DC communications, the uplink carriers in the same frequency band may belong to different TAGs so that the uplink timings of the uplink carriers can be controlled independently. This may permit the base station to transmit a TAG command 820 for each carrier in order to more closely align the carrier timings.

In another example, the uplink carriers in the same frequency band may belong to the same TAG, but may be configured with a timing offset with respect to each other. For example, the timing offset may be determined based on the receive timing difference of the downlink cells associated with the uplink carriers. When the UE receives the TAG command 820 for the TAG, the UE may adjust the transmission timing for the uplink carriers in the TAG. In some examples, this may still result in the determined relative timing difference between the uplink carriers being kept unchanged.

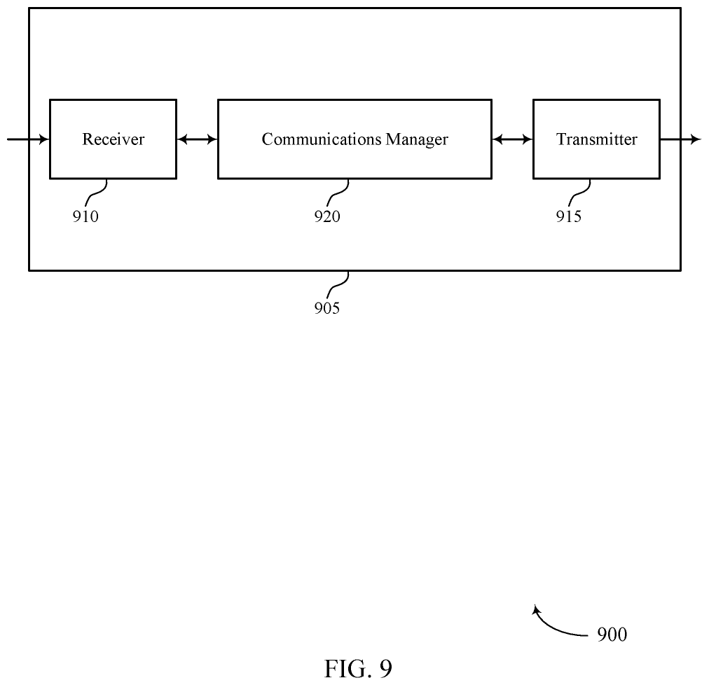

FIG. 9 shows a block diagram 900 of a device 905 that supports intra-band CA/DC in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to intra-band CA/DC). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to intra-band CA/DC). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of intra-band CA/DC as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for identifying a set of carriers within a frequency band for communicating with a base station via either CA or DC. The communications manager 920 may be configured as or otherwise support a means for determining that a first parameter for communications over a first carrier exceeds a threshold with respect to corresponding parameters of other carriers, the first parameter being either a downlink reception parameter or an uplink transmission parameter. The communications manager 920 may be configured as or otherwise support a means for refraining from communicating over the first carrier based on the first parameter exceeding the threshold.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for adapting to receive timing/power differences between intra-band carriers used for CA/DC communications.

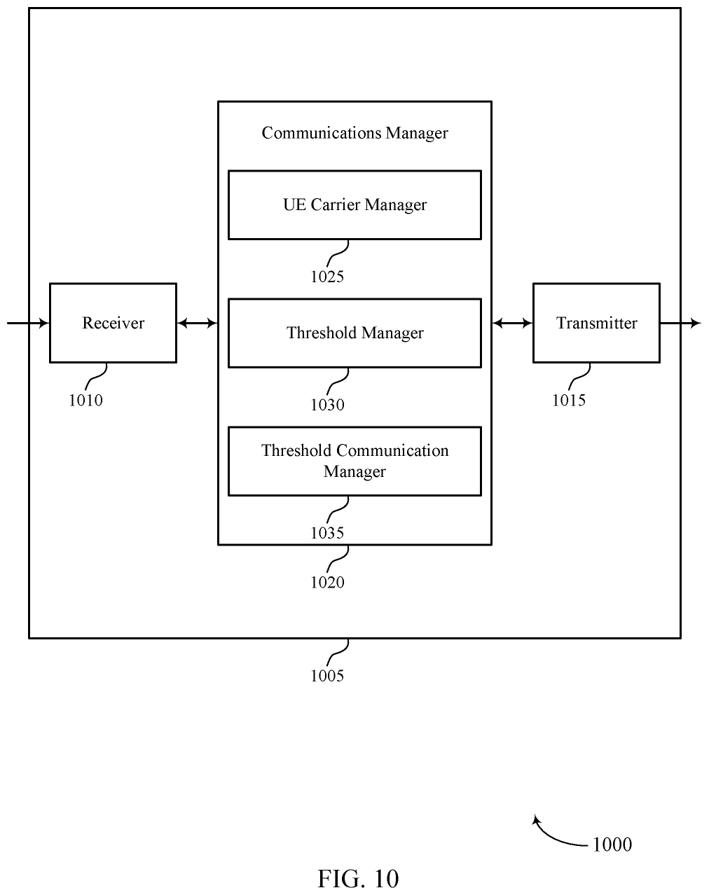

FIG. 10 shows a block diagram 1000 of a device 1005 that supports intra-band CA/DC in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to intra-band CA/DC). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to intra-band CA/DC). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of intra-band CA/DC as described herein. For example, the communications manager 1020 may include a UE carrier manager 1025, a threshold manager 1030, a threshold communication manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The UE carrier manager 1025 may be configured as or otherwise support a means for identifying a set of carriers within a frequency band for communicating with a base station via either CA or DC. The threshold manager 1030 may be configured as or otherwise support a means for determining that a first parameter for communications over a first carrier exceeds a threshold with respect to corresponding parameters of other carriers, the first parameter being either a downlink reception parameter or an uplink transmission parameter. The threshold communication manager 1035 may be configured as or otherwise support a means for refraining from communicating over the first carrier based on the first parameter exceeding the threshold.

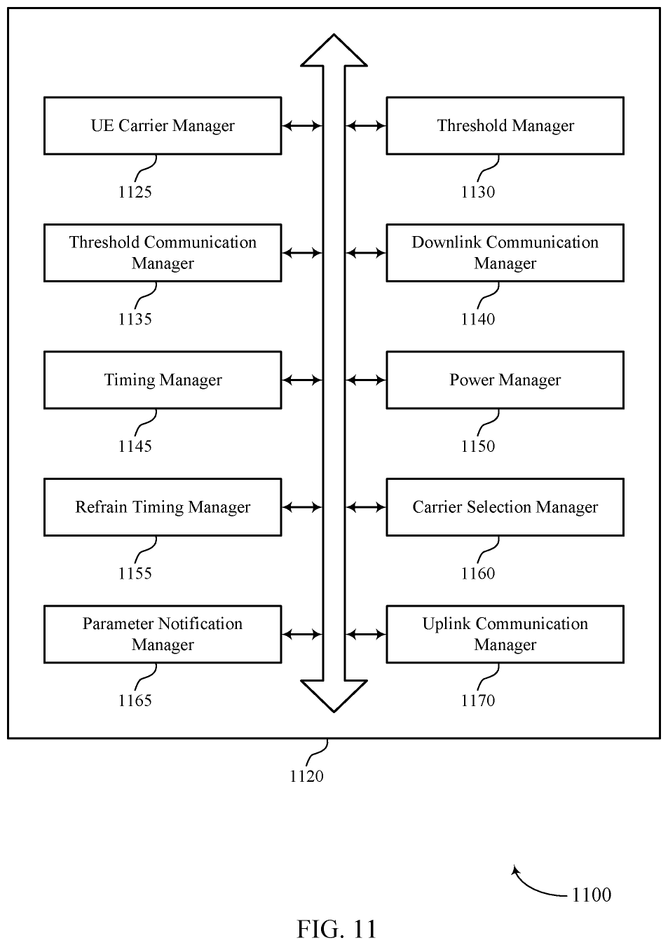

FIG. 11 shows a block diagram 1100 of a communications manager 1120 that supports intra-band CA/DC in accordance with aspects of the present disclosure. The communications manager 1120 may be an example of aspects of a communications manager 920, a communications manager 1020, or both, as described herein. The communications manager 1120, or various components thereof, may be an example of means for performing various aspects of intra-band CA/DC as described herein. For example, the communications manager 1120 may include a UE carrier manager 1125, a threshold manager 1130, a threshold communication manager 1135, a downlink communication manager 1140, a timing manager 1145, a power manager 1150, a refrain timing manager 1155, a carrier selection manager 1160, a parameter notification manager 1165, an uplink communication manager 1170, or any combination thereof. Each of these components may communicate, directly or indirectly, with one another (e.g., via one or more buses).

The communications manager 1120 may support wireless communications at a UE in accordance with examples as disclosed herein. The UE carrier manager 1125 may be configured as or otherwise support a means for identifying a set of carriers within a frequency band for communicating with a base station via either CA or DC. The threshold manager 1130 may be configured as or otherwise support a means for determining that a first parameter for communications over a first carrier exceeds a threshold with respect to corresponding parameters of other carriers, the first parameter being either a downlink reception parameter or an uplink transmission parameter. The threshold communication manager 1135 may be configured as or otherwise support a means for refraining from communicating over the first carrier based on the first parameter exceeding the threshold.

In some examples, to support refraining from communicating over the first carrier, the downlink communication manager 1140 may be configured as or otherwise support a means for refraining from monitoring for the downlink reception on the first carrier.

In some examples, the timing manager 1145 may be configured as or otherwise support a means for determining a downlink receive timing for each carrier in the set of carriers. In some examples, the timing manager 1145 may be configured as or otherwise support a means for determining, based on the downlink receive timing for each carrier, that a downlink receive timing difference associated with the first carrier with respect to other carriers exceeds the threshold, where the first parameter includes the downlink receive timing difference.

In some examples, the power manager 1150 may be configured as or otherwise support a means for determining a receive power for each carrier in the set of carriers. In some examples, the power manager 1150 may be configured as or otherwise support a means for determining, based on the receive power for each carrier, that a downlink receive power difference associated with the first carrier with respect to other carriers exceeds the threshold, where the first parameter includes the downlink receive power difference.

In some examples, the refrain timing manager 1155 may be configured as or otherwise support a means for determining a time period for refraining from communicating over the first carrier based on a downlink reception over a second carrier of the set of carriers and the first parameter exceeding the threshold, where the UE refrains from communicating over the first carrier during the time period.

In some examples, the refrain timing manager 1155 may be configured as or otherwise support a means for transmitting a message indicating UE capability information for a support for communicating using the set of carriers with either the CA or the DC, where the time period is based on the UE capability information. In some examples, the time period includes one or more symbols or one or more slots.

In some examples, the carrier selection manager 1160 may be configured as or otherwise support a means for determining, subsequent to the refraining, that a second parameter for communicating over a second carrier of the set of carriers exceeds the threshold. In some examples, the carrier selection manager 1160 may be configured as or otherwise support a means for communicating over the first carrier and the second carrier based on the first parameter and the second parameter exceeding the threshold.

In some examples, the carrier selection manager 1160 may be configured as or otherwise support a means for determining that the first carrier is associated with a non-primary cell associated with the UE, where the refraining is based on the first carrier being associated with the non-primary cell and the first parameter exceeding the threshold.

In some examples, the carrier selection manager 1160 may be configured as or otherwise support a means for determining that a first downlink reception over the first carrier begins after a second downlink reception over a second carrier of the set of carriers, where the refraining is based on the first downlink reception beginning after the second downlink reception, the first parameter based on a timing difference between the first downlink reception and the second downlink reception.

In some examples, the carrier selection manager 1160 may be configured as or otherwise support a means for determining that a first downlink reception over the first carrier begins before a second downlink reception over a second carrier of the set of carriers, where the refraining is based on the first downlink reception beginning before the second downlink reception, the first parameter based on a timing difference between the first downlink reception and the second downlink reception.

In some examples, the carrier selection manager 1160 may be configured as or otherwise support a means for determining that a first receive power associated with the first carrier is lower than a second receive power level associated with a second carrier of the set of carriers, where the refraining is based on the first receive power being lower than the second receive power, the first parameter based on a receive power difference between the first receive power and the second receive power.

In some examples, the parameter notification manager 1165 may be configured as or otherwise support a means for transmitting a message indicating the first parameter for communications over the first carrier. In some examples, the message is transmitted using a PUCCH message, an PUSCH message, a MAC CE, or a combination thereof, and is transmitted periodically or aperiodically.

In some examples, to support refraining from communicating over the first carrier, the uplink communication manager 1170 may be configured as or otherwise support a means for refraining from transmitting an uplink transmission on the first carrier.

In some examples, the timing manager 1145 may be configured as or otherwise support a means for determining an uplink transmission timing for each carrier in the set of carriers. In some examples, the timing manager 1145 may be configured as or otherwise support a means for determining, based on the uplink transmission timing for each carrier, that an uplink transmit timing difference associated with the first carrier with respect to other carriers exceeds the threshold, where the first parameter includes the uplink transmit timing difference.

In some examples, the power manager 1150 may be configured as or otherwise support a means for determining an uplink transmit power for each carrier in the set of carriers. In some examples, the power manager 1150 may be configured as or otherwise support a means for determining, based on the uplink transmit power for each carrier, that an uplink transmit power difference associated with the first carrier with respect to other carriers exceeds the threshold, where the first parameter includes the uplink transmit power difference.

In some examples, the refrain timing manager 1155 may be configured as or otherwise support a means for determining a time period for refraining from communicating over the first carrier based on an uplink transmission over a second carrier of the set of carriers and the first parameter exceeding the threshold, where the UE refrains from communicating over the first carrier during the time period.

In some examples, the refrain timing manager 1155 may be configured as or otherwise support a means for transmitting, prior to determining that the first parameter exceeds the threshold, a UE capability message indicating a support for communicating over the set of carriers using either the CA or the DC, where the time period is based on the UE capability message. In some examples, the time period includes one or more symbols or one or more slots.

In some examples, the carrier selection manager 1160 may be configured as or otherwise support a means for determining that a first uplink transmission over the first carrier begins after a second uplink transmission over a second carrier of the set of carriers, where the refraining is based on the first uplink transmission beginning after the second uplink transmission, the first parameter based on a timing difference between the first uplink transmission and the second uplink transmission.

In some examples, the carrier selection manager 1160 may be configured as or otherwise support a means for determining that a first uplink transmission over the first carrier begins before a second uplink transmission over a second carrier of the set of carriers, where the refraining is based on the first uplink transmission beginning before the second uplink transmission, the first parameter based on a timing difference between the first uplink transmission and the second uplink transmission.

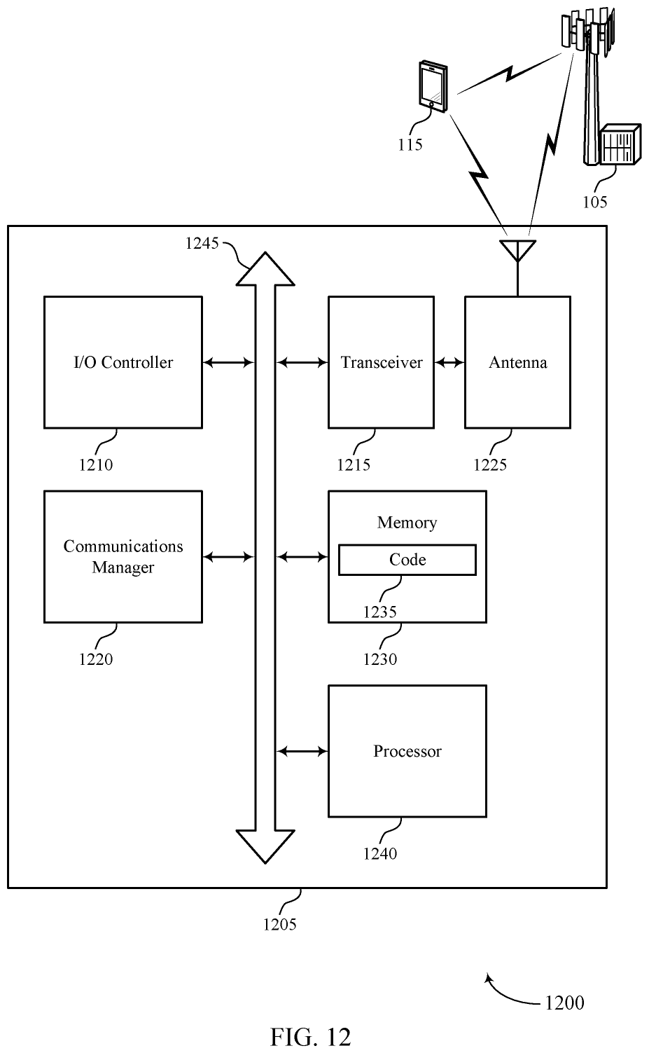

FIG. 12 shows a diagram of a system 1200 including a device 1205 that supports intra-band CA/DC in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting intra-band CA/DC). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for identifying a set of carriers within a frequency band for communicating with a base station via either CA or DC.

The communications manager 1220 may be configured as or otherwise support a means for determining that a first parameter for communications over a first carrier exceeds a threshold with respect to corresponding parameters of other carriers, the first parameter being either a downlink reception parameter or an uplink transmission parameter. The communications manager 1220 may be configured as or otherwise support a means for refraining from communicating over the first carrier based on the first parameter exceeding the threshold.

By including or configuring the communications manager 1220 in accordance with examples as described herein, the device 1205 may support techniques for adapting to receive timing/power differences between intra-band carriers used for CA/DC communications.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of intra-band CA/DC as described herein, or the processor 1240 and the memory 1230 may be otherwise configured to perform or support such operations.

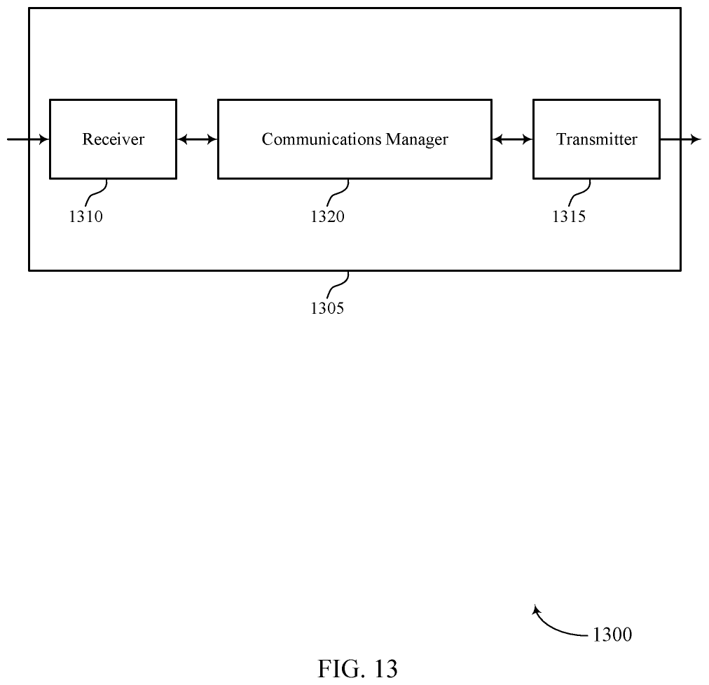

FIG. 13 shows a block diagram 1300 of a device 1305 that supports intra-band CA/DC in accordance with aspects of the present disclosure. The device 1305 may be an example of aspects of a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to intra-band CA/DC). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to intra-band CA/DC). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of intra-band CA/DC as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. For example, the communications manager 1320 may be configured as or otherwise support a means for identifying, for a UE, a set of carriers within a frequency band for communicating with the UE via either CA or DC. The communications manager 1320 may be configured as or otherwise support a means for determining, for each carrier in the set of carriers, a parameter for communications over the carrier within the frequency band, the parameter being either a downlink reception parameter or an uplink transmission parameter. The communications manager 1320 may be configured as or otherwise support a means for determining a threshold with respect to the parameter associated with each carrier of the set of carriers. The communications manager 1320 may be configured as or otherwise support a means for scheduling communications with the UE based on the parameter with respect to the carriers in the set of carriers satisfying the threshold.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for adapting to receive timing/power differences between intra-band carriers used for CA/DC communications.

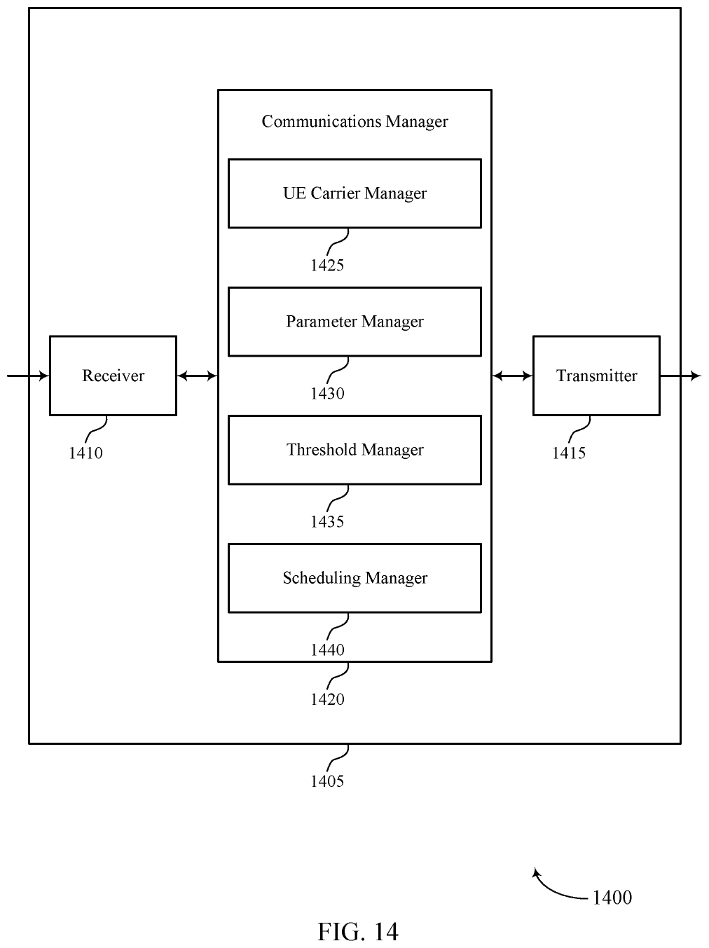

FIG. 14 shows a block diagram 1400 of a device 1405 that supports intra-band CA/DC in accordance with aspects of the present disclosure. The device 1405 may be an example of aspects of a device 1305 or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to intra-band CA/DC). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to intra-band CA/DC). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of intra-band CA/DC as described herein. For example, the communications manager 1420 may include a UE carrier manager 1425, a parameter manager 1430, a threshold manager 1435, a scheduling manager 1440, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. The UE carrier manager 1425 may be configured as or otherwise support a means for identifying, for a UE, a set of carriers within a frequency band for communicating with the UE via either CA or DC. The parameter manager 1430 may be configured as or otherwise support a means for determining, for each carrier in the set of carriers, a parameter for communications over the carrier within the frequency band, the parameter being either a downlink reception parameter or an uplink transmission parameter. The threshold manager 1435 may be configured as or otherwise support a means for determining a threshold with respect to the parameter associated with each carrier of the set of carriers. The scheduling manager 1440 may be configured as or otherwise support a means for scheduling communications with the UE based on the parameter with respect to the carriers in the set of carriers satisfying the threshold.

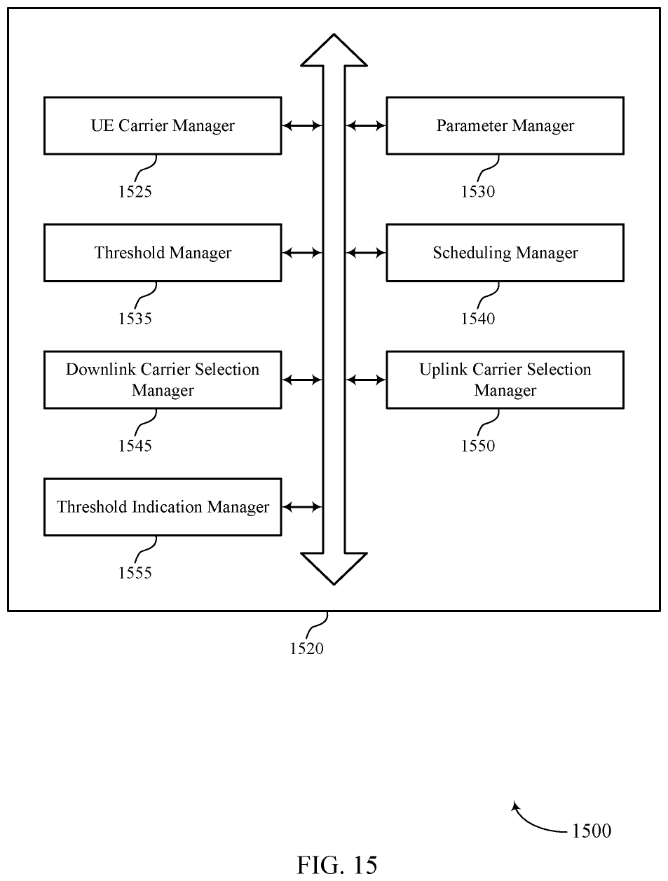

FIG. 15 shows a block diagram 1500 of a communications manager 1520 that supports intra-band CA/DC in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of intra-band CA/DC as described herein. For example, the communications manager 1520 may include a UE carrier manager 1525, a parameter manager 1530, a threshold manager 1535, a scheduling manager 1540, a downlink carrier selection manager 1545, an uplink carrier selection manager 1550, a threshold indication manager 1555, or any combination thereof. Each of these components may communicate, directly or indirectly, with one another (e.g., via one or more buses).

The communications manager 1520 may support wireless communications at a base station in accordance with examples as disclosed herein. The UE carrier manager 1525 may be configured as or otherwise support a means for identifying, for a UE, a set of carriers within a frequency band for communicating with the UE via either CA or DC. The parameter manager 1530 may be configured as or otherwise support a means for determining, for each carrier in the set of carriers, a parameter for communications over the carrier within the frequency band, the parameter being either a downlink reception parameter or an uplink transmission parameter. The threshold manager 1535 may be configured as or otherwise support a means for determining a threshold with respect to the parameter associated with each carrier of the set of carriers. The scheduling manager 1540 may be configured as or otherwise support a means for scheduling communications with the UE based on the parameter with respect to the carriers in the set of carriers satisfying the threshold.

In some examples, to support scheduling, the downlink carrier selection manager 1545 may be configured as or otherwise support a means for refraining from scheduling a downlink transmission to the UE on a carrier based on a maximum receive timing difference of the downlink transmission exceeding the threshold with respect to downlink transmissions to the UE over other carriers in the set of carriers.

In some examples, to support scheduling, the downlink carrier selection manager 1545 may be configured as or otherwise support a means for refraining from scheduling a downlink transmission to the UE on a carrier based on a maximum receive power difference of the downlink transmission exceeding the threshold with respect to downlink transmissions to the UE over other carriers in the set of carriers.

In some examples, to support scheduling, the uplink carrier selection manager 1550 may be configured as or otherwise support a means for refraining from scheduling an uplink transmission from the UE on a carrier based on a maximum transmit timing difference of the uplink transmission exceeding the threshold with respect to uplink transmissions from the UE over other carriers in the set of carriers.

In some examples, to support scheduling, the uplink carrier selection manager 1550 may be configured as or otherwise support a means for refraining from scheduling an uplink transmission from the UE on a carrier based on a maximum receive power difference of the uplink transmission exceeding the threshold with respect to a receive power of uplink transmissions from the UE over other carriers in the set of carriers.

In some examples, the threshold indication manager 1555 may be configured as or otherwise support a means for receiving a UE capability message indicating the threshold supported by the UE for either CA or DC over the set of carriers within the frequency band, where the threshold includes a maximum receive timing difference, a maximum transmit timing difference, a maximum receive power difference, or a combination thereof.

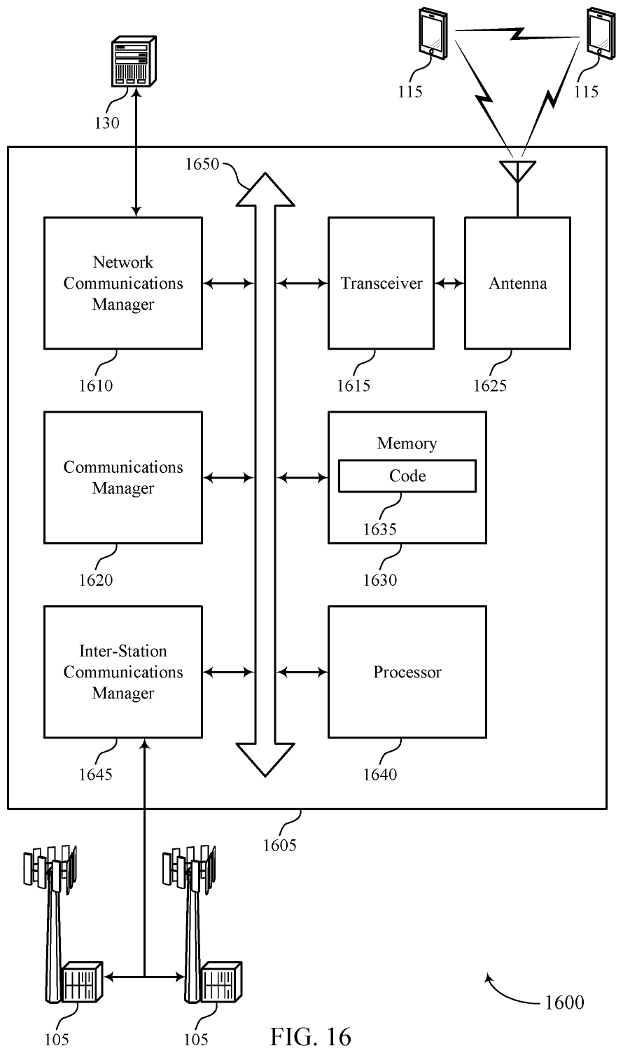

FIG. 16 shows a diagram of a system 1600 including a device 1605 that supports intra-band CA/DC in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network 130 (e.g., via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting intra-band CA/DC). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communications at a base station in accordance with examples as disclosed herein. For example, the communications manager 1620 may be configured as or otherwise support a means for identifying, for a UE, a set of carriers within a frequency band for communicating with the UE via either CA or DC. The communications manager 1620 may be configured as or otherwise support a means for determining, for each carrier in the set of carriers, a parameter for communications over the carrier within the frequency band, the parameter being either a downlink reception parameter or an uplink transmission parameter. The communications manager 1620 may be configured as or otherwise support a means for determining a threshold with respect to the parameter associated with each carrier of the set of carriers. The communications manager 1620 may be configured as or otherwise support a means for scheduling communications with the UE based on the parameter with respect to the carriers in the set of carriers satisfying the threshold.

By including or configuring the communications manager 1620 in accordance with examples as described herein, the device 1605 may support techniques for adapting to receive timing/power differences between intra-band carriers used for CA/DC communications.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of intra-band CA/DC as described herein, or the processor 1640 and the memory 1630 may be otherwise configured to perform or support such operations.

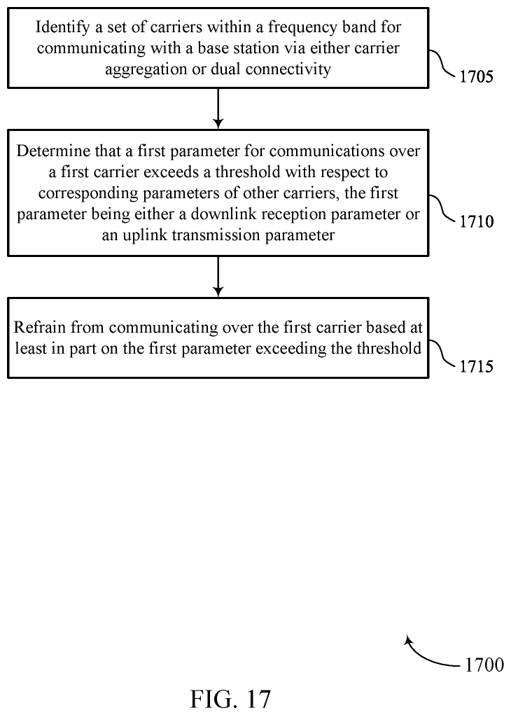

FIG. 17 shows a flowchart illustrating a method 1700 that supports intra-band CA/DC in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1705, the method may include identifying a set of carriers within a frequency band for communicating with a base station via either CA or DC. The operations of 1705 may be performed in accordance with examples as disclosed herein. In some examples, aspects of the operations of 1705 may be performed by a UE carrier manager 1125 as described with reference to FIG. 11.

At 1710, the method may include determining that a first parameter for communications over a first carrier exceeds a threshold with respect to corresponding parameters of other carriers, the first parameter being either a downlink reception parameter or an uplink transmission parameter. The operations of 1710 may be performed in accordance with examples as disclosed herein. In some examples, aspects of the operations of 1710 may be performed by a threshold manager 1130 as described with reference to FIG. 11.

At 1715, the method may include refraining from communicating over the first carrier based on the first parameter exceeding the threshold. The operations of 1715 may be performed in accordance with examples as disclosed herein. In some examples, aspects of the operations of 1715 may be performed by a threshold communication manager 1135 as described with reference to FIG. 11.

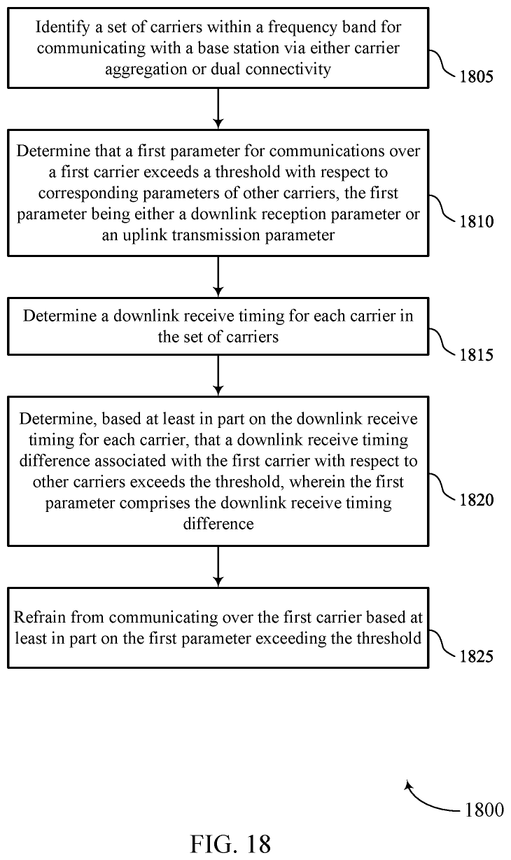

FIG. 18 shows a flowchart illustrating a method 1800 that supports intra-band CA/DC in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1805, the method may include identifying a set of carriers within a frequency band for communicating with a base station via either CA or DC. The operations of 1805 may be performed in accordance with examples as disclosed herein. In some examples, aspects of the operations of 1805 may be performed by a UE carrier manager 1125 as described with reference to FIG. 11.

At 1810, the method may include determining that a first parameter for communications over a first carrier exceeds a threshold with respect to corresponding parameters of other carriers, the first parameter being either a downlink reception parameter or an uplink transmission parameter. The operations of 1810 may be performed in accordance with examples as disclosed herein. In some examples, aspects of the operations of 1810 may be performed by a threshold manager 1130 as described with reference to FIG. 11.

At 1815, the method may include determining a downlink receive timing for each carrier in the set of carriers. The operations of 1815 may be performed in accordance with examples as disclosed herein. In some examples, aspects of the operations of 1815 may be performed by a timing manager 1145 as described with reference to FIG. 11.

At 1820, the method may include determining, based on the downlink receive timing for each carrier, that a downlink receive timing difference associated with the first carrier with respect to other carriers exceeds the threshold, where the first parameter includes the downlink receive timing difference. The operations of 1820 may be performed in accordance with examples as disclosed herein. In some examples, aspects of the operations of 1820 may be performed by a timing manager 1145 as described with reference to FIG. 11.

At 1825, the method may include refraining from communicating over the first carrier based on the first parameter exceeding the threshold. The operations of 1825 may be performed in accordance with examples as disclosed herein. In some examples, aspects of the operations of 1825 may be performed by a threshold communication manager 1135 as described with reference to FIG. 11.

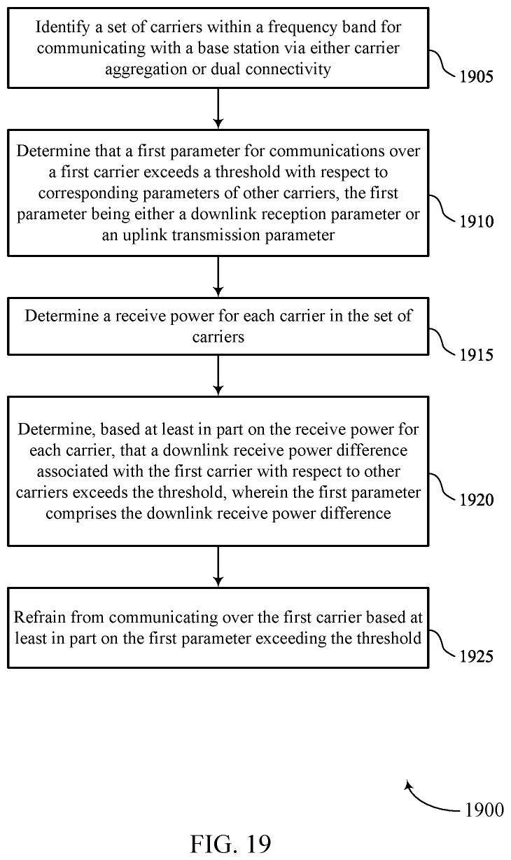

FIG. 19 shows a flowchart illustrating a method 1900 that supports intra-band CA/DC in accordance with aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1905, the method may include identifying a set of carriers within a frequency band for communicating with a base station via either CA or DC. The operations of 1905 may be performed in accordance with examples as disclosed herein. In some examples, aspects of the operations of 1905 may be performed by a UE carrier manager 1125 as described with reference to FIG. 11.

At 1910, the method may include determining that a first parameter for communications over a first carrier exceeds a threshold with respect to corresponding parameters of other carriers, the first parameter being either a downlink reception parameter or an uplink transmission parameter. The operations of 1910 may be performed in accordance with examples as disclosed herein. In some examples, aspects of the operations of 1910 may be performed by a threshold manager 1130 as described with reference to FIG. 11.

At 1915, the method may include determining a receive power for each carrier in the set of carriers. The operations of 1915 may be performed in accordance with examples as disclosed herein. In some examples, aspects of the operations of 1915 may be performed by a power manager 1150 as described with reference to FIG. 11.

At 1920, the method may include determining, based on the receive power for each carrier, that a downlink receive power difference associated with the first carrier with respect to other carriers exceeds the threshold, where the first parameter includes the downlink receive power difference. The operations of 1920 may be performed in accordance with examples as disclosed herein. In some examples, aspects of the operations of 1920 may be performed by a power manager 1150 as described with reference to FIG. 11.

At 1925, the method may include refraining from communicating over the first carrier based on the first parameter exceeding the threshold. The operations of 1925 may be performed in accordance with examples as disclosed herein. In some examples, aspects of the operations of 1925 may be performed by a threshold communication manager 1135 as described with reference to FIG. 11.

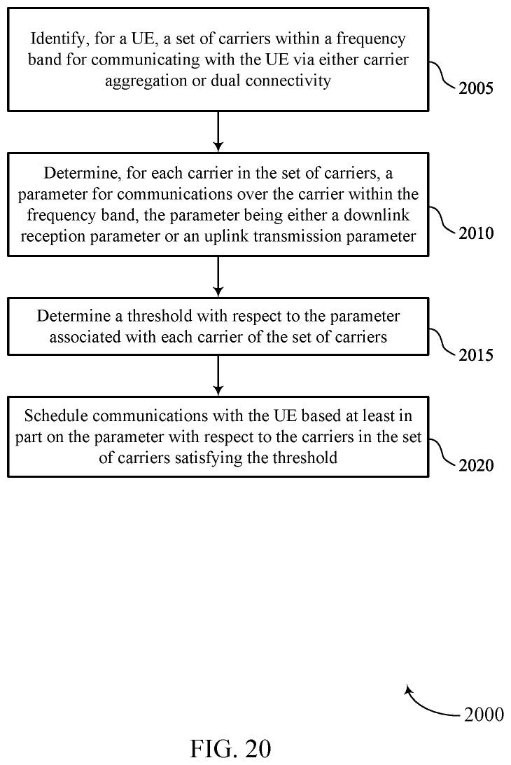

FIG. 20 shows a flowchart illustrating a method 2000 that supports intra-band CA/DC in accordance with aspects of the present disclosure. The operations of the method 2000 may be implemented by a base station or its components as described herein. For example, the operations of the method 2000 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2005, the method may include identifying, for a UE, a set of carriers within a frequency band for communicating with the UE via either CA or DC. The operations of 2005 may be performed in accordance with examples as disclosed herein. In some examples, aspects of the operations of 2005 may be performed by a UE carrier manager 1525 as described with reference to FIG. 15.

At 2010, the method may include determining, for each carrier in the set of carriers, a parameter for communications over the carrier within the frequency band, the parameter being either a downlink reception parameter or an uplink transmission parameter.

The operations of 2010 may be performed in accordance with examples as disclosed herein. In some examples, aspects of the operations of 2010 may be performed by a parameter manager 1530 as described with reference to FIG. 15.

At 2015, the method may include determining a threshold with respect to the parameter associated with each carrier of the set of carriers. The operations of 2015 may be performed in accordance with examples as disclosed herein. In some examples, aspects of the operations of 2015 may be performed by a threshold manager 1535 as described with reference to FIG. 15.

At 2020, the method may include scheduling communications with the UE based on the parameter with respect to the carriers in the set of carriers satisfying the threshold. The operations of 2020 may be performed in accordance with examples as disclosed herein. In some examples, aspects of the operations of 2020 may be performed by a scheduling manager 1540 as described with reference to FIG. 15.

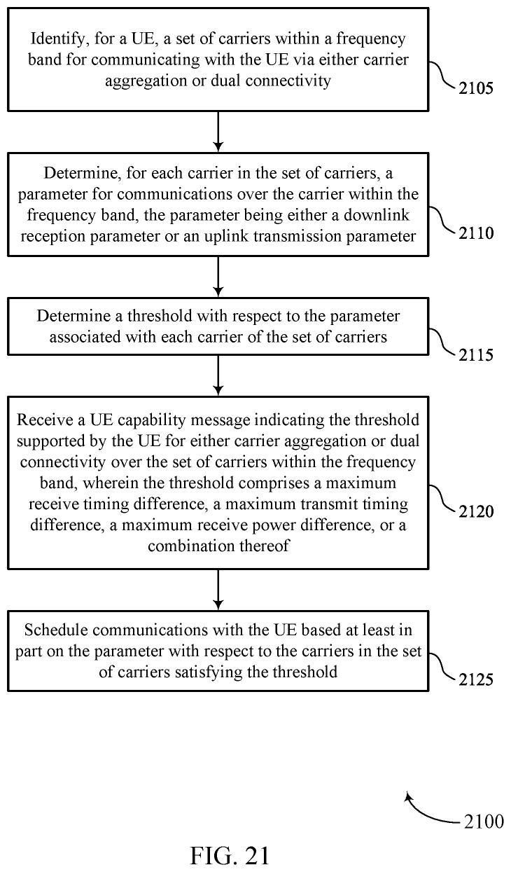

FIG. 21 shows a flowchart illustrating a method 2100 that supports intra-band CA/DC in accordance with aspects of the present disclosure. The operations of the method 2100 may be implemented by a base station or its components as described herein. For example, the operations of the method 2100 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 2105, the method may include identifying, for a UE, a set of carriers within a frequency band for communicating with the UE via either CA or DC. The operations of 2105 may be performed in accordance with examples as disclosed herein. In some examples, aspects of the operations of 2105 may be performed by a UE carrier manager 1525 as described with reference to FIG. 15.

At 2110, the method may include determining, for each carrier in the set of carriers, a parameter for communications over the carrier within the frequency band, the parameter being either a downlink reception parameter or an uplink transmission parameter. The operations of 2110 may be performed in accordance with examples as disclosed herein.

In some examples, aspects of the operations of 2110 may be performed by a parameter manager 1530 as described with reference to FIG. 15.

At 2115, the method may include determining a threshold with respect to the parameter associated with each carrier of the set of carriers. The operations of 2115 may be performed in accordance with examples as disclosed herein. In some examples, aspects of the operations of 2115 may be performed by a threshold manager 1535 as described with reference to FIG. 15.

At 2120, the method may include receiving a UE capability message indicating the threshold supported by the UE for either CA or DC over the set of carriers within the frequency band, where the threshold includes a maximum receive timing difference, a maximum transmit timing difference, a maximum receive power difference, or a combination thereof. The operations of 2120 may be performed in accordance with examples as disclosed herein. In some examples, aspects of the operations of 2120 may be performed by a threshold indication manager 1555 as described with reference to FIG. 15.

At 2125, the method may include scheduling communications with the UE based on the parameter with respect to the carriers in the set of carriers satisfying the threshold. The operations of 2125 may be performed in accordance with examples as disclosed herein. In some examples, aspects of the operations of 2125 may be performed by a scheduling manager 1540 as described with reference to FIG. 15.

The following provides an overview of aspects of the present disclosure:

Aspect 1: A method for wireless communications at a UE, comprising: identifying a set of carriers within a frequency band for communicating with a base station via either CA or DC; determining that a first parameter for communications over a first carrier exceeds a threshold with respect to corresponding parameters of other carriers, the first parameter being either a downlink reception parameter or an uplink transmission parameter; and refraining from communicating over the first carrier based at least in part on the first parameter exceeding the threshold.

Aspect 2: The method of aspect 1, wherein refraining from communicating over the first carrier comprises: refraining from monitoring for the downlink reception on the first carrier.

Aspect 3: The method of any of aspects 1 through 2, further comprising: determining a downlink receive timing for each carrier in the set of carriers; and determining, based at least in part on the downlink receive timing for each carrier, that a downlink receive timing difference associated with the first carrier with respect to other carriers exceeds the threshold, wherein the first parameter comprises the downlink receive timing difference.

Aspect 4: The method of any of aspects 1 through 3, further comprising: determining a receive power for each carrier in the set of carriers; and determining, based at least in part on the receive power for each carrier, that a downlink receive power difference associated with the first carrier with respect to other carriers exceeds the threshold, wherein the first parameter comprises the downlink receive power difference.

Aspect 5: The method of any of aspects 1 through 4, further comprising: determining a time period for refraining from communicating over the first carrier based at least in part on a downlink reception over a second carrier of the set of carriers and the first parameter exceeding the threshold, wherein the UE refrains from communicating over the first carrier during the time period.

Aspect 6: The method of aspect 5, further comprising: transmitting a message indicating UE capability information for a support for communicating using the set of carriers with either the CA or the DC, wherein the time period is based at least in part on the UE capability information.

Aspect 7: The method of any of aspects 5 through 6, wherein the time period comprises one or more symbols or one or more slots.

Aspect 8: The method of any of aspects 1 through 7, further comprising: determining, subsequent to the refraining, that a second parameter for communicating over a second carrier of the set of carriers exceeds the threshold; and communicating over the first carrier and the second carrier based at least in part on the first parameter and the second parameter exceeding the threshold.

Aspect 9: The method of any of aspects 1 through 8, further comprising: determining that the first carrier is associated with a non-primary cell associated with the UE, wherein the refraining is based at least in part on the first carrier being associated with the non-primary cell and the first parameter exceeding the threshold.

Aspect 10: The method of any of aspects 1 through 9, further comprising: determining that a first downlink reception over the first carrier begins after a second downlink reception over a second carrier of the set of carriers, wherein the refraining is based at least in part on the first downlink reception beginning after the second downlink reception, the first parameter based at least in part on a timing difference between the first downlink reception and the second downlink reception.

Aspect 11: The method of any of aspects 1 through 10, further comprising: determining that a first downlink reception over the first carrier begins before a second downlink reception over a second carrier of the set of carriers, wherein the refraining is based at least in part on the first downlink reception beginning before the second downlink reception, the first parameter based at least in part on a timing difference between the first downlink reception and the second downlink reception.

Aspect 12: The method of any of aspects 1 through 11, further comprising: determining that a first receive power associated with the first carrier is lower than a second receive power level associated with a second carrier of the set of carriers, wherein the refraining is based at least in part on the first receive power being lower than the second receive power, the first parameter based at least in part on a receive power difference between the first receive power and the second receive power.

Aspect 13: The method of any of aspects 1 through 12, further comprising: transmitting a message indicating the first parameter for communications over the first carrier.

Aspect 14: The method of aspect 13, wherein the message is transmitted using a PUCCH message, an PUSCH message, a MAC CE, or a combination thereof, and is transmitted periodically or aperiodically.

Aspect 15: The method of any of aspects 1 through 14, wherein refraining from communicating over the first carrier comprises: refraining from transmitting an uplink transmission on the first carrier.

Aspect 16: The method of any of aspects 1 through 15, further comprising: determining an uplink transmission timing for each carrier in the set of carriers; and determining, based at least in part on the uplink transmission timing for each carrier, that an uplink transmit timing difference associated with the first carrier with respect to other carriers exceeds the threshold, wherein the first parameter comprises the uplink transmit timing difference.

Aspect 17: The method of any of aspects 1 through 16, further comprising: determining an uplink transmit power for each carrier in the set of carriers; and determining, based at least in part on the uplink transmit power for each carrier, that an uplink transmit power difference associated with the first carrier with respect to other carriers exceeds the threshold, wherein the first parameter comprises the uplink transmit power difference.

Aspect 18: The method of any of aspects 1 through 17, further comprising: determining a time period for refraining from communicating over the first carrier based at least in part on an uplink transmission over a second carrier of the set of carriers and the first parameter exceeding the threshold, wherein the UE refrains from communicating over the first carrier during the time period.

Aspect 19: The method of aspect 18, further comprising: transmitting, prior to determining that the first parameter exceeds the threshold, a UE capability message indicating a support for communicating over the set of carriers using either the CA or the DC, wherein the time period is based at least in part on the UE capability message.

Aspect 20: The method of any of aspects 18 through 19, wherein the time period comprises one or more symbols or one or more slots.

Aspect 21: The method of any of aspects 1 through 20, further comprising: determining that a first uplink transmission over the first carrier begins after a second uplink transmission over a second carrier of the set of carriers, wherein the refraining is based at least in part on the first uplink transmission beginning after the second uplink transmission, the first parameter based at least in part on a timing difference between the first uplink transmission and the second uplink transmission.

Aspect 22: The method of any of aspects 1 through 21, further comprising: determining that a first uplink transmission over the first carrier begins before a second uplink transmission over a second carrier of the set of carriers, wherein the refraining is based at least in part on the first uplink transmission beginning before the second uplink transmission, the first parameter based at least in part on a timing difference between the first uplink transmission and the second uplink transmission.

Aspect 23: A method for wireless communications at a base station, comprising: identifying, for a UE, a set of carriers within a frequency band for communicating with the UE via either CA or DC; determining, for each carrier in the set of carriers, a parameter for communications over the carrier within the frequency band, the parameter being either a downlink reception parameter or an uplink transmission parameter; determining a threshold with respect to the parameter associated with each carrier of the set of carriers; and scheduling communications with the UE based at least in part on the parameter with respect to the carriers in the set of carriers satisfying the threshold.

Aspect 24: The method of aspect 23, wherein the scheduling comprises: refraining from scheduling a downlink transmission to the UE on a carrier based at least in part on a maximum receive timing difference of the downlink transmission exceeding the threshold with respect to downlink transmissions to the UE over other carriers in the set of carriers.

Aspect 25: The method of any of aspects 23 through 24, wherein the scheduling comprises: refraining from scheduling a downlink transmission to the UE on a carrier based at least in part on a maximum receive power difference of the downlink transmission exceeding the threshold with respect to downlink transmissions to the UE over other carriers in the set of carriers.

Aspect 26: The method of any of aspects 23 through 25, wherein the scheduling comprises: refraining from scheduling an uplink transmission from the UE on a carrier based at least in part on a maximum transmit timing difference of the uplink transmission exceeding the threshold with respect to uplink transmissions from the UE over other carriers in the set of carriers.

Aspect 27: The method of any of aspects 23 through 26, wherein the scheduling comprises: refraining from scheduling an uplink transmission from the UE on a carrier based at least in part on a maximum receive power difference of the uplink transmission exceeding the threshold with respect to a receive power of uplink transmissions from the UE over other carriers in the set of carriers.

Aspect 28: The method of any of aspects 23 through 27, further comprising: receiving a UE capability message indicating the threshold supported by the UE for either CA or DC over the set of carriers within the frequency band, wherein the threshold comprises a maximum receive timing difference, a maximum transmit timing difference, a maximum receive power difference, or a combination thereof.

Aspect 29: An apparatus for wireless communications at a UE, comprising a processor; memory coupled with the processor; and instructions stored in the memory and executable by the processor to cause the apparatus to perform a method of any of aspects 1 through 22.

Aspect 30: An apparatus for wireless communications at a UE, comprising at least one means for performing a method of any of aspects 1 through 22.

Aspect 31: A non-transitory computer-readable medium storing code for wireless communications at a UE, the code comprising instructions executable by a processor to perform a method of any of aspects 1 through 22.

Aspect 32: An apparatus for wireless communications at a base station, comprising a processor; memory coupled with the processor; and instructions stored in the memory and executable by the processor to cause the apparatus to perform a method of any of aspects 23 through 28.

Aspect 33: An apparatus for wireless communications at a base station, comprising at least one means for performing a method of any of aspects 23 through 28.

Aspect 34: A non-transitory computer-readable medium storing code for wireless communications at a base station, the code comprising instructions executable by a processor to perform a method of any of aspects 23 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
identifying a set of carriers within a frequency band for communicating with a base station via either carrier aggregation or dual connectivity;
determining that a first parameter for communications over a first carrier exceeds a threshold with respect to corresponding parameters of other carriers, the first parameter being either a downlink reception parameter or an uplink transmission parameter; and
refraining from communicating over the first carrier based at least in part on the first parameter exceeding the threshold.

2. The method of claim 1, wherein refraining from communicating over the first carrier comprises:
refraining from monitoring for the downlink reception on the first carrier.

3. The method of claim 1, further comprising:
determining a downlink receive timing for each carrier in the set of carriers; and
determining, based at least in part on the downlink receive timing for each carrier, that a downlink receive timing difference associated with the first carrier with respect to other carriers exceeds the threshold, wherein the first parameter comprises the downlink receive timing difference.

4. The method of claim 1, further comprising:
determining a receive power for each carrier in the set of carriers; and
determining, based at least in part on the receive power for each carrier, that a downlink receive power difference associated with the first carrier with respect to other carriers exceeds the threshold, wherein the first parameter comprises the downlink receive power difference.

5. The method of claim 1, further comprising:
determining a time period for refraining from communicating over the first carrier based at least in part on a downlink reception over a second carrier of the set of carriers and the first parameter exceeding the threshold, wherein the UE refrains from communicating over the first carrier during the time period.

6. The method of claim 5, further comprising:
transmitting a message indicating UE capability information for a support for communicating using the set of carriers with either the carrier aggregation or the dual connectivity, wherein the time period is based at least in part on the UE capability information.

7. The method of claim 5, wherein the time period comprises one or more symbols or one or more slots.

8. The method of claim 1, further comprising:
determining, subsequent to the refraining, that a second parameter for communicating over a second carrier of the set of carriers exceeds the threshold; and
communicating over the first carrier and the second carrier based at least in part on the first parameter and the second parameter exceeding the threshold.

9. The method of claim 1, further comprising:
determining that the first carrier is associated with a non-primary cell associated with the UE, wherein the refraining is based at least in part on the first carrier being associated with the non-primary cell and the first parameter exceeding the threshold.

10. The method of claim 1, further comprising:
determining that a first downlink reception over the first carrier begins after a second downlink reception over a second carrier of the set of carriers, wherein the refraining is based at least in part on the first downlink reception beginning after the second downlink reception, the first parameter based at least in part on a timing difference between the first downlink reception and the second downlink reception.

11. The method of claim 1, further comprising:
determining that a first downlink reception over the first carrier begins before a second downlink reception over a second carrier of the set of carriers, wherein the refraining is based at least in part on the first downlink reception beginning before the second downlink reception, the first parameter based at least in part on a timing difference between the first downlink reception and the second downlink reception.

12. The method of claim 1, further comprising:
determining that a first receive power associated with the first carrier is lower than a second receive power level associated with a second carrier of the set of carriers, wherein the refraining is based at least in part on the first receive power being lower than the second receive power, the first parameter based at least in part on a receive power difference between the first receive power and the second receive power.

13. The method of claim 1, further comprising:
transmitting a message indicating the first parameter for communications over the first carrier.

14. The method of claim 13, wherein the message is transmitted using a physical uplink control channel (PUCCH) message, a physical uplink shared channel (PUSCH) message, a medium access control (MAC) control element (CE), or a combination thereof, and is transmitted periodically or aperiodically.

15. The method of claim 1, wherein refraining from communicating over the first carrier comprises:
refraining from transmitting an uplink transmission on the first carrier.

16. The method of claim 1, further comprising:
determining an uplink transmission timing for each carrier in the set of carriers; and
determining, based at least in part on the uplink transmission timing for each carrier, that an uplink transmit timing difference associated with the first carrier with respect to other carriers exceeds the threshold, wherein the first parameter comprises the uplink transmit timing difference.

17. The method of claim 1, further comprising:
determining an uplink transmit power for each carrier in the set of carriers; and
determining, based at least in part on the uplink transmit power for each carrier, that an uplink transmit power difference associated with the first carrier with respect to other carriers exceeds the threshold, wherein the first parameter comprises the uplink transmit power difference.

18. The method of claim 1, further comprising:
determining a time period for refraining from communicating over the first carrier based at least in part on an uplink transmission over a second carrier of the set of carriers and the first parameter exceeding the threshold, wherein the UE refrains from communicating over the first carrier during the time period.

19. The method of claim 18, further comprising:
transmitting, prior to determining that the first parameter exceeds the threshold, a UE capability message indicating a support for communicating over the set of carriers using either the carrier aggregation or the dual connectivity, wherein the time period is based at least in part on the UE capability message.

20. The method of claim 18, wherein the time period comprises one or more symbols or one or more slots.

21. The method of claim 1, further comprising:
determining that a first uplink transmission over the first carrier begins after a second uplink transmission over a second carrier of the set of carriers, wherein the refraining is based at least in part on the first uplink transmission beginning after the second uplink transmission, the first parameter based at least in part on a timing difference between the first uplink transmission and the second uplink transmission.

22. The method of claim 1, further comprising:
determining that a first uplink transmission over the first carrier begins before a second uplink transmission over a second carrier of the set of carriers, wherein the refraining is based at least in part on the first uplink transmission beginning before the second uplink transmission, the first parameter based at least in part on a timing difference between the first uplink transmission and the second uplink transmission.

23. A method for wireless communications at a base station, comprising:
identifying, for a user equipment (UE), a set of carriers within a frequency band for communicating with the UE via either carrier aggregation or dual connectivity;
determining, for each carrier in the set of carriers, a parameter for communications over the carrier within the frequency band, the parameter being either a downlink reception parameter or an uplink transmission parameter;
determining a threshold with respect to the parameter associated with each carrier of the set of carriers; and
scheduling communications with the UE based at least in part on the parameter with respect to the carriers in the set of carriers satisfying the threshold.

24. The method of claim 23, wherein the scheduling comprises:
refraining from scheduling a downlink transmission to the UE on a carrier based at least in part on a maximum receive timing difference of the downlink transmission exceeding the threshold with respect to downlink transmissions to the UE over other carriers in the set of carriers.

25. The method of claim 23, wherein the scheduling comprises:
refraining from scheduling a downlink transmission to the UE on a carrier based at least in part on a maximum receive power difference of the downlink transmission exceeding the threshold with respect to downlink transmissions to the UE over other carriers in the set of carriers.

26. The method of claim 23, wherein the scheduling comprises:
refraining from scheduling an uplink transmission from the UE on a carrier based at least in part on a maximum transmit timing difference of the uplink transmission exceeding the threshold with respect to uplink transmissions from the UE over other carriers in the set of carriers.

27. The method of claim 23, wherein the scheduling comprises:
refraining from scheduling an uplink transmission from the UE on a carrier based at least in part on a maximum receive power difference of the uplink transmission exceeding the threshold with respect to a receive power of uplink transmissions from the UE over other carriers in the set of carriers.

28. The method of claim 23, further comprising:
receiving a UE capability message indicating the threshold supported by the UE for either carrier aggregation or dual connectivity over the set of carriers within the frequency band, wherein the threshold comprises a maximum receive timing difference, a maximum transmit timing difference, a maximum receive power difference, or a combination thereof.

29. An apparatus for wireless communications at a user equipment (UE), comprising:
a processor;
memory coupled with the processor; and
instructions stored in the memory and executable by the processor to cause the apparatus to:
identify a set of carriers within a frequency band for communicating with a base station via either carrier aggregation or dual connectivity;
determine that a first parameter for communications over a first carrier exceeds a threshold with respect to corresponding parameters of other carriers, the first parameter being either a downlink reception parameter or an uplink transmission parameter; and
refrain from communicating over the first carrier based at least in part on the first parameter exceeding the threshold.

30. An apparatus for wireless communications at a base station, comprising:
a processor;
memory coupled with the processor; and
instructions stored in the memory and executable by the processor to cause the apparatus to:
identify, for a user equipment (UE), a set of carriers within a frequency band for communicating with the UE via either carrier aggregation or dual connectivity;
determine, for each carrier in the set of carriers, a parameter for communications over the carrier within the frequency band, the parameter being either a downlink reception parameter or an uplink transmission parameter;
determine a threshold with respect to the parameter associated with each carrier of the set of carriers; and
schedule communications with the UE based at least in part on the parameter with respect to the carriers in the set of carriers satisfying the threshold.
